(19) United States
(12) Patent Application Publication
(10) Pub. No.: US 2015/0380114 A1
(43) Pub. Date: Dec. 31, 2015

(54) METHOD AND APPARATUS OF CONFINING HIGH ENERGY CHARGED PARTICLES IN MAGNETIC CUSP CONFIGURATION

(71) Applicant: Energy Matter Conversion Corporation, San Diego, CA (US)

(72) Inventors: Jaeyoung PARK, La Jolla, CA (US); Nicholas Anthony KRALL, Del Mar, CA (US); Paul Earl SIECK, San Diego, CA (US)

(21) Appl. No.: 14/645,306

(22) Filed: Mar. 11, 2015

Related U.S. Application Data
(60) Provisional application No. 61/951,387, filed on Mar. 11, 2014.

(51) Int. Cl. G21B 1/05

(52) U.S. Cl. CPC G21B 1/05

(57) ABSTRACT

An apparatus and method for generating nuclear fusion reactions using a plasma initiator, and electron injector and a magnetic coil cusp confinement arrangement. The plasma initiator produces the high beta plasma inside the reaction chamber for electron confinement in the magnetic cusp arrangement. The electron injector produces a plasma potential well within the reaction chamber to confine ions and accelerates ions to fusion relevant energies within the reaction chamber.

This invention was made with US Government support under contract N68936-09-0125 awarded by the Department of Defense. The Government has certain rights in the invention.

### DESCRIPTION OF RELATED ART

1. Field of Embodiments of the Invention

Embodiments of the present invention relates to methods and apparatuses to generate and confine high energy plasma. The high energy plasma may be used to produce nuclear fusion reactions.

2. Brief Description of the Related Art

The use of magnetic fields to confine high temperature plasmas has been one of the main pathways pursued in controlled thermonuclear fusion research since 1950s. Several magnetic field configurations such as magnetic pinch, tokamak, stellerator, and magnetic minor, have been explored for confinement of high temperature plasmas in order to achieve net power generation from fusion reactions. Substantial progress has been made in confining high temperature plasmas which resulted in fusion power generation of 16 MW at Joint European Torus tokamak in 1997, compared to an input power of 23 MW. However, one of the critical technical challenges related to the magnetically confined fusion device is the plasma instability inside the confining magnetic fields. For example, magnetohydrodynamic (MHD) instabilities driven by plasma current or plasma pressure such as kink and interchange instability can abruptly disrupt the plasma confinement by tearing apart the magnetic fields and expelling the plasma. As such, the plasma instability limits the maximum operating plasma current or pressure in the device and increases the required reactor size to achieve net fusion power. Moreover, a large engineering safety margin is required to prevent reactor failure in the event of a major disruption, thus increasing engineering complexities and reactor cost.

Magnetic Cusp Configurations

Magnetic cusp configuration provides excellent plasma stability due to the convex magnetic field curvature towards the confined plasma system in the center, as shown in FIG. 1A [1]. In FIGS. 1A and 1B, the stippled area indicates the extent of the plasma within the plasma chamber. Experimentally, the cusp field configurations have operated with very high plasma pressures up to β=1. Plasma beta, β, is defined as the ratio of plasma pressure to the confining magnetic field pressure, β=Pₚₗₐₛₘₐ/(B²/2μₒ), where Pₚₗₐₛₘₐ is the plasma pressure, μₒ is the magnetic permeability, and B is the magnetic field strength. In this disclosure, the beta value of the cusp system is determined with the value of plasma pressure equal to an average plasma pressure in the confined plasma volume inside the cusp and with the value of magnetic pressure (B_{cusp}²/2μₒ) using B_{cusp}, the magnetic field strength at the cusp points in vacuum. It is further noted that the plasma pressure is given by nκ_{B}T, where n is the plasma density, κ_{B} is Boltzmann's constant and T is the plasma temperature. In the case of beam type plasma, the average beam energy will be used to determine the plasma pressure, for example, beam plasma pressure=n_{beam}×E_{beam}, where n_{beam} is the beam plasma density and E_{beam} is the average beam energy. This will be analogus to the distinction between static pressure and dynamic pressure in fluid dynamics.

In comparison, the design parameter for the International Thermonuclear International Reactor (ITER), a proposed large scale tokamak device to achieve net fusion power output, is β˜0.03. Since the fusion power output scales as β², high beta operation is advantageous for a compact size economical fusion reactor. In 1950s, research groups at Los Alamos National Laboratory (LANL) and New York University (NYU) had investigated utilizing cusp magnetic fields as a possible configuration for a controlled thermonuclear reactor [1-3]. However, poor plasma confinement related to the open magnetic field structures of the cusp configuration posed a serious challenge. As a result, most of the R&D efforts aimed at utilizing the magnetic cusp field configuration stopped with the exception of theoretical work by Grad and others at NYU.

Grad and others at NYU predicted theoretically that the plasma confinement properties of the open cusp field configuration can be greatly improved if the magnetic field exhibits a sharp boundary separating field-free high beta plasmas on the one side (e.g., central portion of confinement region) and vacuum region with magnetic fields on the other side, as shown in FIG. 1B [2] where again, the stippled areas represent the plasma within the plasma chamber. In this disclosure, a high beta indicates a beta value of 0.2 or above. This value of beta is high as compared to the relatively low beta values between 0.03 and 0.06 in other magnetic confinement devices such as tokamak and magnetic minors. Inside the boundary layer, magnetic fields are negligibly small due to the diamagnetic effects of the high beta plasmas. Outside the boundary layer, the plasma pressure is effectively zero due to the rapid charge particle loss in the open field configuration. The plasma loss across this thin boundary layer is greatly reduced since the majority of outward charged particle trajectories involve specular reflection back to the inner region, as shown in FIG. 1C. Only particles whose directions of motion are very close to the cusp axis will leave the inner region and get lost, as shown in FIG. 1D, which shows the individual electron trajectories in a hexahedral coil cusp magnetic fields. To calculate plasma loss rate, losses are considered to occur at a “hole” near the cusp axis and the size of the “hole” is conjectured to be comparable to the charged particle gyro-radius.

Grad and his colleagues had theoretically assumed that this “hole” would have a size comparable to the electron gyro-radius, and it may be possible to construct a net power producing reactor if one can create sharp magnetic field boundaries in the cusp configuration [2]. Equation 1 gives the electron loss rate for a sharp magnetic field boundary with a high β plasma state such as that shown in FIG. 1B.

Equation 1: During high β plasma state, electron loss rate is given as,

$$\frac{{I}_{e}}{e} = \frac{π}{9} {n}_{e} {υ}_{e} \times {π ( {r}_{e}^{gyro} )}^{2} and {r}_{e}^{gyro} = \frac{{m}_{e} {υ}_{e}}{{eB}_{cusp}}$$

corresponding to an electron confinement time of

$${τ}_{e} = ( \frac{1.5}{π {N}_{cusp}} ) \times * ( \frac{2 {R}_{system}}{{υ}_{e}} ) \times ( \frac{4 π {R}_{system}^{2}}{{π ( {r}_{e}^{gyro} )}^{2}} )$$

where Iₑ is the electron loss current, e is the electron charge, nₑ is the electron density (assumed to be equal to the ion density), νₑ is the electron velocity, rₑ^{gyro} is the electron gyro-radius at the cusp points, mₑ is the electron mass, B_{cusp} is the magnetic field strength at the cusp points, N_{cusp} is the number of cusp points in the system and R_{system} is the cusp confinement system radius. It is noted that the units and formula in the present disclosure follows the convention in the widely used Naval Research Laboratory Plasma Formulary [4]. The above equation applies to ion loss rates where the electron mass, density and gyro radius are replaced with the corresponding parameters for the ion.

Based on the electron loss rate in Equation 1, Grad and his colleague indicated that it may be possible to build a net power producing fusion reactor using a magnetic cusp field configuration. For example, FIG. 2 shows a small compact fusion reactor with a plasma size, i.e., a cups confinement system radius (e.g., cusp confinement radius R_{system}) of 80 cm radius based on a 6 coil magnetic cusp configuration. It has 14 cusp points or openings (N_{cusp}=14) as shown by representative points C in FIG. 2, and operates at 5 Tesla of magnetic fields at the magnetic cusp points. Based on Equation 1, an electron confinement time is 0.13 second for 50 keV electrons in the plasma. If a β=1 condition is used to characterize the confined plasma, the corresponding plasma density would be 1.2×10¹⁵ cm⁻³ for a 5 Tesla field, leading to nτₑ value of 1.6×10¹⁴ s/cm³. It is noted that the requied nτ value is 1.5×10¹⁴ s/cm³ or higher for a net power producing D-T fusion reactor according to the well known Lawson criteria. In comparison, a nuclear fusion reactor based on a tokamak concept will require a much larger device size to meet the Lawson criterion.

Grad and his colleague further disclosed the use of a shock-tube type of plasma injector or time varying magnetic fields as a means to create the sharp boundary. Marshall and Tuck at LANL disclosed and conducted preliminary experimental work injecting plasma jets into the cusp fields using magnetically accelerated arc sources [5, 6]. Additionally, several research groups around the world attempted to demonstrate the improved plasma confinement as postulated by Grad and their efforts are summarized in the review articles by Spalding and Haines [7, 8]. However, efforts to experimentally demonstrated the improved plasma confinement as postulated by Grad have not been successful. Later, Pechacek and others at NRL utilized the laser ablation of a solid pellet to produce a high beta (i.e. beta=1) plasma in a two dimensional spindle cusp configuration [9]. Their results showed the size of the geometrical loss “hole” of the cusp fields is on the order of the ion gyro-radius, rather than the electron gyro-radius. Since the ion energy required for fusion reaction is very high, on the order of 10 keV-500 keV, the corresponding geometrical loss hole size will be substantial for a fusion reactor based on the magnetic cusp configuration. The gyro radius is 0.65 cm for 50 keV deuterium ions and 5 Tesla of magnetic field strength, compared to 0.01 cm for 50 keV electrons at the same magnetic fields. It was deemed that the magnetic cusp configuration may not be suitable for a practical power generating fusion reactor due to the high rate of plasma loss, if the loss “hole” size is comparable to ion gyro-radius,

Though progresses were made in producing high beta plasma in the cusp, the previous works on cusp plasma confinement devices were limited to low temperature plasmas between 10 and 100 eV. Grad had pointed out that one inherent property of cusp confinement is that high energy particles are lost much more quickly compared to the low energy particles. As such, previous works utilized relatively cold plasmas with plasma temperatures between 10 and 100 eV to produce the initial high beta plasma in the cusp. However, the problem of how one can accelerate ions in the cusp to fusion relevant energies between 10 keV-500 keV had not been solved.

Inertial Electrostatic Confinement

On the other hand, several research groups have been investigating the viability of the inertial electrostatic confinement (IEC) system, based on the work of Farnsworth, Hirsch, Elmore, Tuck and Watson, for a potential neutron source, medical isotope production and power producing nuclear fusion reactors [10-13]. In the case of IEC system, the ion acceleration and confinement for fusion reactivity comes from the electric fields in the plasma generated by negatively biased physical electrodes (for example, semi-transparent grids) or excess electrons in the plasmas from electron beam injection. For the IEC system relevant to the present disclosure, the electric fields produce a negative electrostatic potential well. The potential value in the central region is more negative compared to the potential value in the outer region. As such, the ions gain energy as they move toward the central region where highly energetic ions can now overcome strong electrostatic repulsion prior to fusion reaction. The main technical challenges for the IEC device are high rates of ion or electron loss to the electrodes resulting in poor energy efficiency. For example, typical beam electrons only oscillate 10 to 20 times inside the system after the beam injection before hitting the electrodes, resulting in a very short confinement time. As a result, the amount of fusion power generated by IEC systems has been less than 0.01% of the input power to date, limiting commercial applications of IEC systems.

In 1985, Bussard invented a fusion device, later termed the “Polywell” reactor, which combines the magnetic cusp configuration and the IEC concept as shown in FIG. 3 [14]. Bussard enumerated the following five key ideas. 1) use of magnetic cusp configuration based on the magnetohydrodynamic stability, 2) use of polyhedral shape coils to limit the electrons loss to point cusps, 3) use of excess electrons in the device, called “virtual cathode”, to create a potential well in the device as a means to confine ions, 4) injecting electrons at high energies between 10 keV to more than 1 MeV to create negative potential wells that can accelerate ions to fusion relevant energies, and 5) ion addition to provide fusion fuels. The main advance of Polywell reactor over the traditional IEC system is the reduced loss of high energy electron beams by the use of a cusp magnetic field.

One of the challenges related to the Polywell reactor is the start up method. The initial efforts to produce strong electric fields for ion acceleration inside the Polywell cusp configuration failed due to poor confinement of the electron beam during the start-up phase. As described in Krall et al [16], the negative potential well produced by the electron beam injection rapidly decayed away within 0.3 ms when the plasma density was increased from 5.0×10⁶ cm⁻³ to 1.1×10⁹ cm⁻³ In order to overcome the poor confinement of the electron beam during start up, Bussard later expanded his invention by introducing a concept called, “Wiffle-Ball (WB)” effects. The WB effect is described as an inflation of the magnetic field by increasing plasma pressure in the cusp. It is noted that while the phenomenology of WB is different from the high beta plasma in the magnetic cusp by Grad and others, the electron loss rate for the WB effect is conjectured to be similar to the loss rate given in Equation 1. In order to achieve the WB effects, Bussard proposed the use of intense electron beam injection, plasma recirculation along the cusp magnetic fields, and rapid background gas ionization with the use of high voltage on the surface of the coil structure [15]. However, the attempts to produce the WB effects using the above methods did not succeed and the problem of poor confinement of electron beams in the Polywell device has not be solved.

### BRIEF DESCRIPTION OF THE DRAWINGS

FIG. 1A is an illustration of a prior art magnetic cusp configuration having convex magnetic field curvature and a low beta plasma;

FIG. 1B is an illustration of a prior art magnetic cusp configuration exhibiting sharp boundary regions separating a magnetic field-free high beta plasma regions from a magnetic field vacuum region;

FIG. 1C is an illustration of a prior art magnetic cusp configuration showing specula reflections of charged particles at the cusp boundary;

FIG. 1D is an illustration of electron trajectories in a prior art hexahedral coil cusp configuration;

FIG. 2 is an illustration of a prior art small compact fusion reactor with a cusp confinement system size of 80 cm radius based on a 6 coil magnetic cusp configuration;

FIG. 3 is an illustration of a prior art Polywell reactor which combines magnetic cusp configurations with an IEC system;

FIG. 4 shows an apparatus having cusp magnetic fields, a plasma injector and an electron beam injector in accordance with embodiments of the invention;

FIG. 5A shows numerically computed electron trajectories for the six coil cusp magnetic configuration of FIG. 2 or 4;

FIG. 5B is a graph showing the number of electrons remaining inside the plasma chamber of FIG. 2 as a function of time;

FIG. 6 shows the experimental test system that was constructed and operated to validate the start up scheme in accordance with embodiments of the present invention;

FIG. 7A illustrates a co-axial plasma injector for use in embodiments of the invention;

FIG. 7B illustrates the use of multiple plasma injectors in accordance with embodiments of the invention;

FIGS. 8A and 8B illustrate the use of one or more high power lasers for initiating plasma formation within the plasma chamber;

FIGS. 9A-9H illustrate various configurations of pinch plasma intiators and the operation modes used to initiate plasma formation within the plasma chamber;

FIGS. 10A and 10B show the experimental results obtained by operation of the apparatus of FIG. 6;

FIGS. 11A-11D illustrate various magnetic cusp configurations that may be utilized in embodiments of the invention;

FIG. 12 shows another embodiment of the invention using a neutral beam injector; and

FIGS. 13A-13C illustrate pulse timing of plasma initiators.

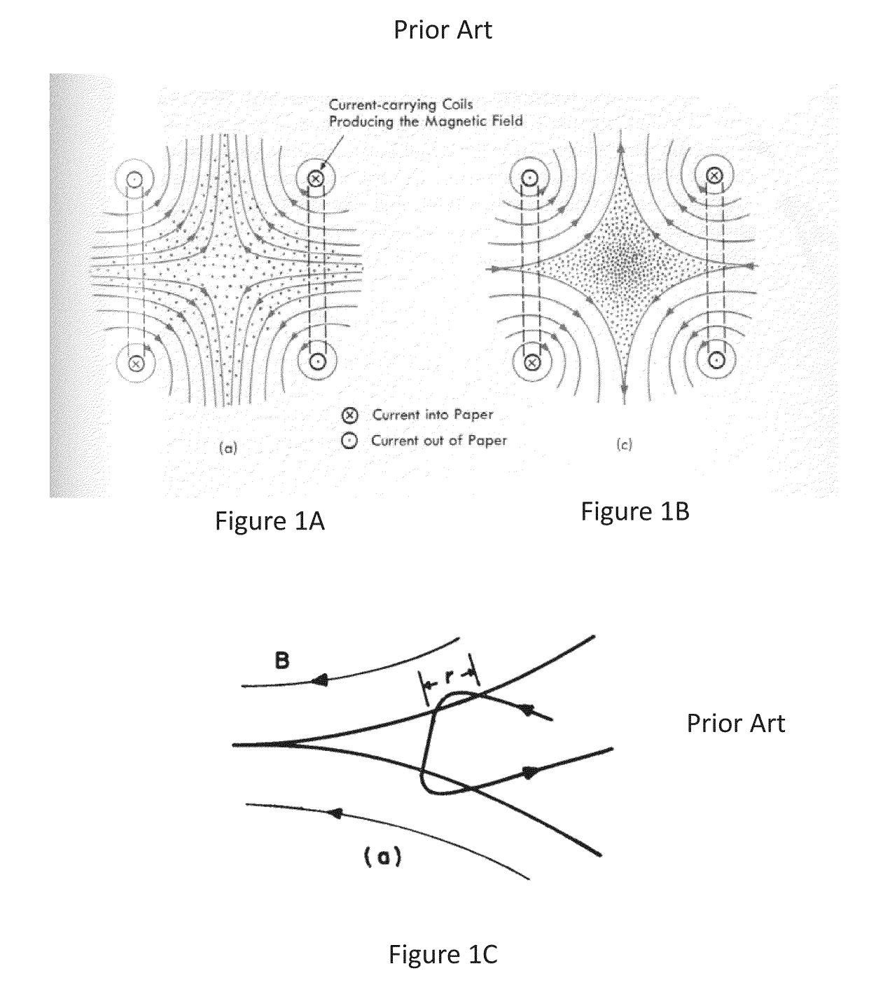

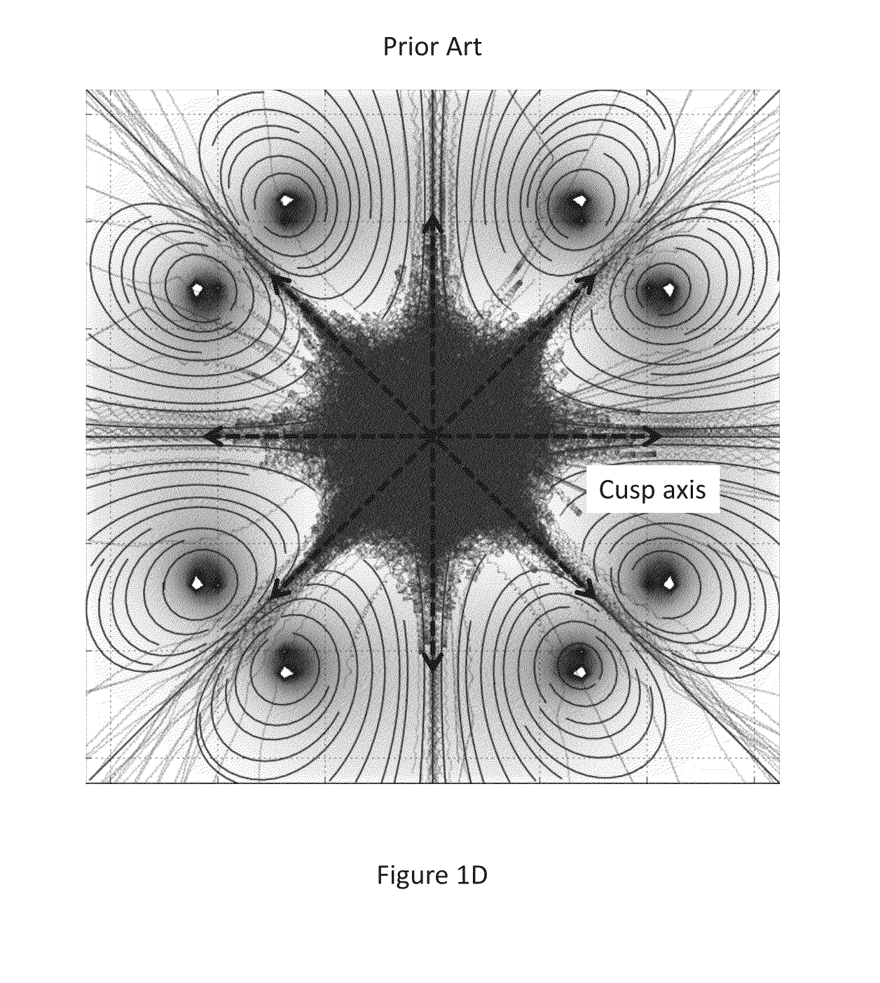

### DETAILED DESCRIPTION OF PREFERRED EMBODIMENTS

In accordance with embodiments of the present invention, there are described methods and apparatus that establish good electron beam confinement in a cusp magnetic field configuration by rapidly creating high beta plasmas in the central confinement region. Subsequent to the formation of the high beta plasma in the central confinement region, and resulting enhanced electron confinement, electron beam injection is utilized to form a negative potential well within the central confinement region.

While it was postulated that high beta plasma would improve plasma confinement in the cusp system, the problem of how to sustain high beta plasma and how to heat ions of the high beta plasma to fusion relevant energies was not solved. In accordance with embodiments of the invention, it has been found that the high beta plasma, formed by plasma initiators, enhances the confinement time of electrons from an electron beam injected into the cusp system, and that this injected electron beam can provide a means to sustain the high beta plasma and to accelerate ions to fusion relevant energy once the high beta plasma in the cusp system is produced with the use of plasma initiators during start up. After the electron beam confinement is enhanced, the injected electron beam can provide efficient heating by transferring its energy to the high beta plasma to sustain the high beta plasma by compensating for the natural cooling of the plasma. In addition, the injected electrons can form a negative potential well to accelerate ions of the high beta plasma to fusion relevant energy. In accordance with embodiments of the invention, the electron beam power requirement to sustain the high beta plasma and to produce a sufficiently deep negative potential well (e.g. more than 10 kV) in the cusp system is much higher without the use of plasma initiators during the start up, compared to the electron beam power required to sustain the high beta plasma and to produce a sufficiently deep negative potential well with the use of the plasma initiators. The reduced electron beam power requirements are of significant practical importance in achieving the desired conditions for fusion reactions in regard to the following potential applications such as neutron generation, medical isotope production, transmutation of nuclear wastes and fusion power plants.

### Requirements for an Initial Plasma Injector

Like a conventional internal combustion engine, embodiments of the present invention utilize specialized start up steps in order to achieve the high beta plasma state leading to enhanced confinement for injected electrons. In embodiments of a useful fusion reactor for neutron generation, medical isotope production, transmutation of nuclear wastes and fusion power plants, the enhanced electron beam confinement results in greatly reduced electron beam power to form a negative potential well for fusion reactions.

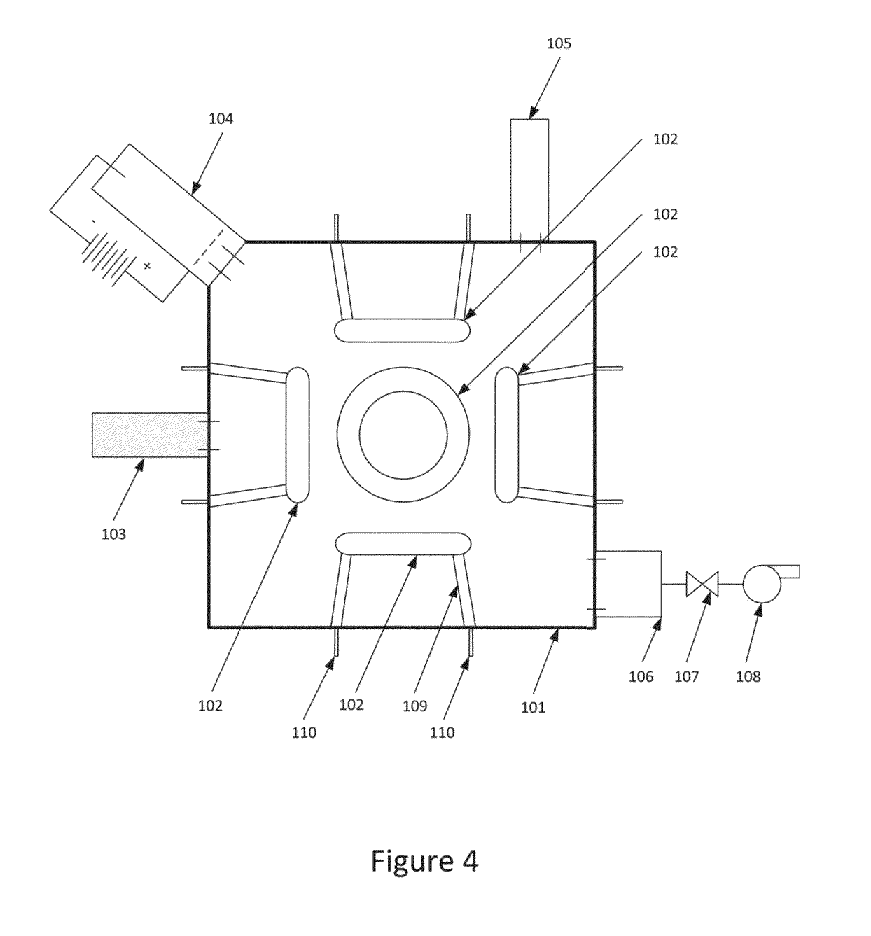

The apparatus in FIG. 4 comprises a vacuum enclosure (reactor chamber) 101, coils 102 generating cusp magnetic fields within a cusp magnetic confinement region, one or more plasma injectors for high β plasma start up 103, one or more electron beam injectors 104, and a fusion fuel injection system 105 to replenish ions. The vacuum condition in the device is maintained by one or more pumping port 106, gas valve system 107, and vacuum pump system 108. Each coil system 102 is supported by mechanical support structure 109, which includes a power delivery and cooling system 110. Though not explicitly drawn, the apparatus in FIG. 4 may include add-on systems to utilize the nuclear fusion reactions that take place inside the reactor for neutron generation, medical isotope production, transmutation of nuclear wastes and fusion power plants. It is noted that the embodiment as shown in FIG. 4 does not utilize electrodes within the vacuum enclosure 101.

Embodiments of the invention utilize multiple coils 102 to generate magnetic fields. The current in the coils can be carried by either metal conductors such as copper or superconductors such as Nb₃Sn, NbTi, and MgB₂ via a feedthrough system which may be part of the power delivery and cooling system 110. In order to achieve good electron beam confinement as described in Equation 1, at least one plasma injector (or more generally “initiator” as discussed below) 103 is utilized to initiate the reactor operation. Various types of plasma injectors can be used as long as the injection parameters meet the specific criteria, which will be described in detail below.

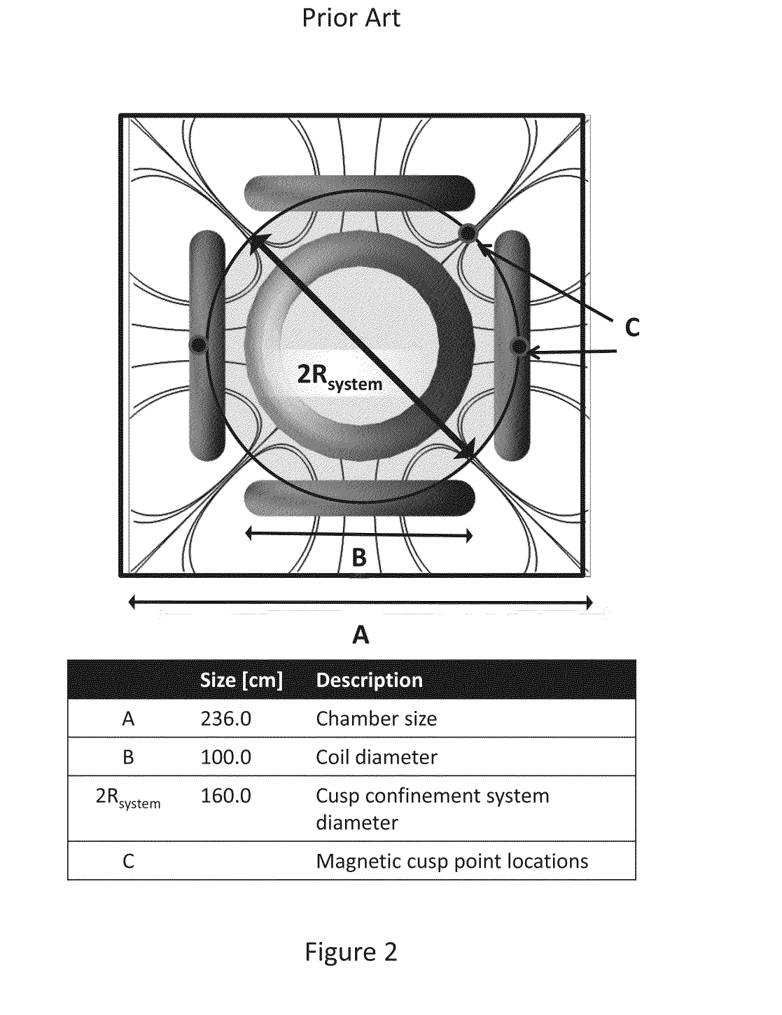

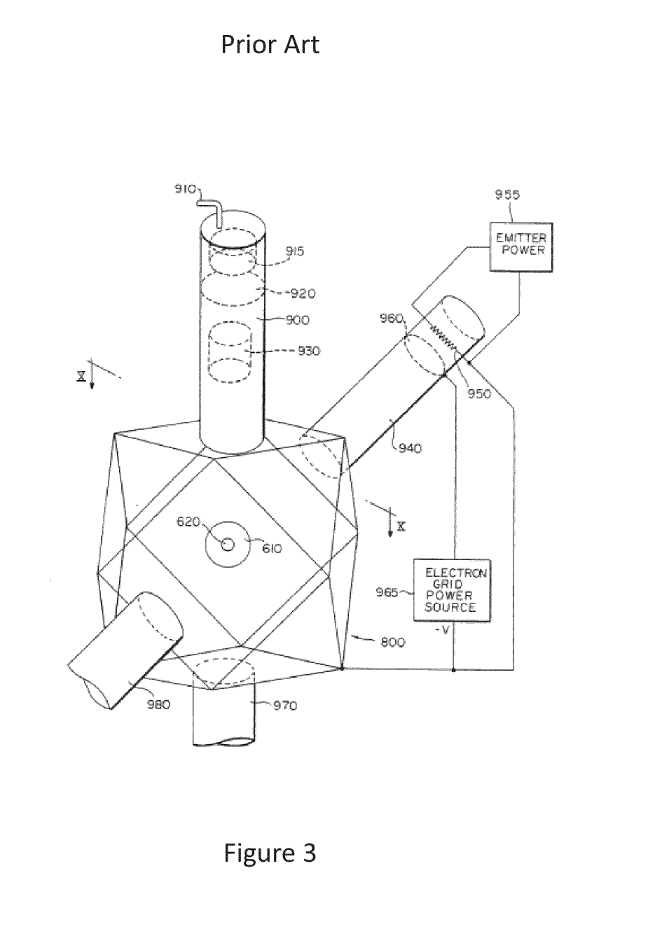

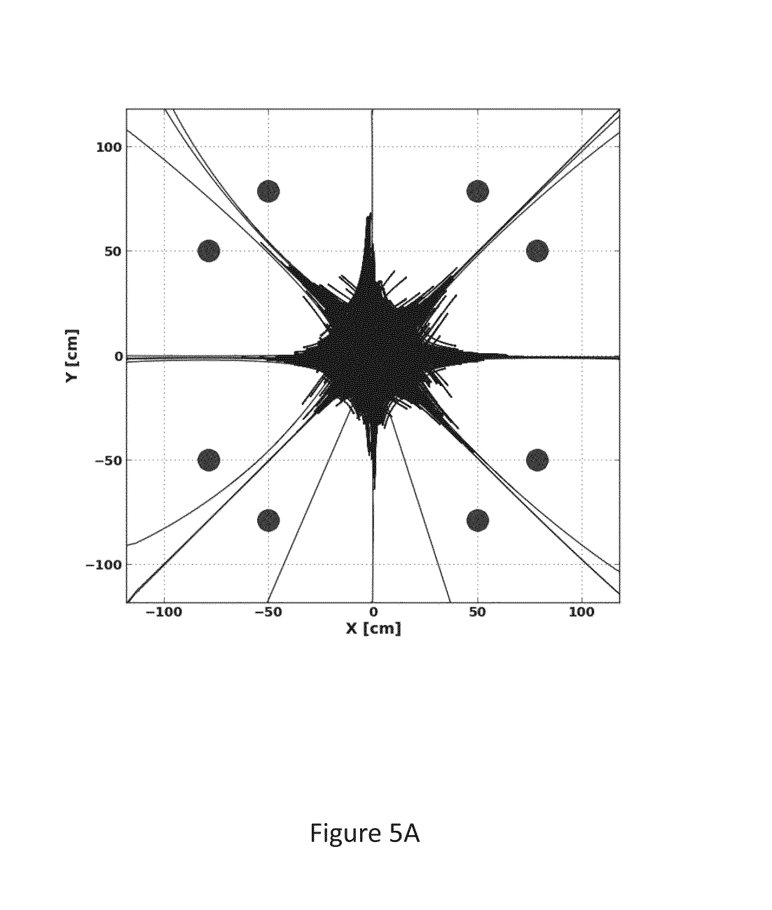

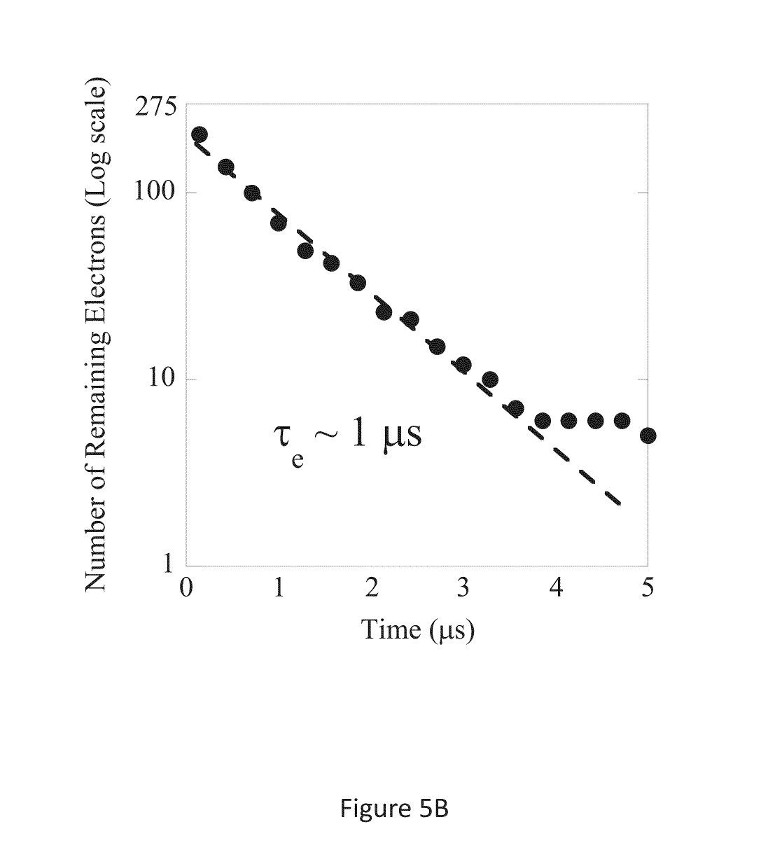

The challenge of the plasma start up in the magnetic cusp configuration stems from very rapid plasma loss during the initial stage when the plasma density is low. FIG. 5A shows the collection of 25 individual electron trajectories in a 6 coil cusp configuration as shown in FIG. 2, computed by a 4^{th} order Runge-Kutta particle motion solver. Each coil is energized by 10.8 MA turns of current and produces 5.0 Tesla magnetic fields at the cusp points. The size of coil is 50 cm of major radius and 9.25 cm of minor radius. In this cusp system, for purposes of the calculation, electrons are assumed to be randomly initiated in the central core region inside a radius of 15.8 cm with a kinetic energy of 50 keV and random velocity directions. The central core size of 15.8 cm is chosen for the purpose of calculation. The above parameters are initial conditions chosen for the purpose of the 4^{th} order calculation. Each electron motion is treated as a “test particle” and only the electron interaction with the magnetic fields is considered. For purposes of the 4^{th} order calculation, the collective dynamics of electrons such as self-consistent electric and magnetic field generation by electron charge and current as well as collisions among themselves, are ignored. This calculation approximates the behavior of collisionless electron dynamics during the initial stage when the plasma density in the cusp is low, and is still a good approximation even with high electron densities on the order of 10¹⁵ cm⁻³. This is because an electron energy at 50 keV undergoes only one collision per 0.4 ms on average with other electrons and ions inside a dense plasma at 1×10¹⁵ cm⁻³ and may thus be considered “collisionless”. As shown in FIG. 5A, electrons are initially bounced back to the central region due to the stronger magnetic fields near the coils, which can be described as “mirror confinement”. Over time, however, electrons leave the system along the magnetic cusp axis when their outward motion is aligned to the magnetic cusp axis. In the calculation, the electron is considered lost and no longer confined if it reaches the wall of the vacuum chamber.

In order to estimate an average electron loss rate, the same 4^{th} order Runge-Kutta particle motion solver was executed with an initial electron number of 275 to provide better statistics compared to 25 test particles. The graph in FIG. 5B shows the number of total electrons inside the cusp confinement system radius of 80 cm as a function of time with 275 electrons at t=0. The result shows a rapid decrease of confined electrons in the cusp region with an estimated confinement time of ˜1 μs (from e-folding time of confined electrons) before the electron leaves the system, indicating rapid and collisionless loss of high energy electrons inside the magnetic cusp system.

The results of FIG. 5B were expanded by executing a large number of particle motion solvers for various initial conditions of electron energy, magnetic field value and cusp confinement system radius. Equation 2 summarizes this effort with an approximate electron and ion confinement time for the 6 coil cusp configuration from the fitting of these numerical results with electron energy, magnetic field value and the system size.

Equation 2: Electron and ion confinement time (τₑ and τᵢ) in the low β magnetic cusp device

τₑ(R_{system},Eₑ,Bₘₐₓ)≈0.5×(2R_{system}/νₑ)/×M*

τᵢ(R_{system},Eᵢ,Bₘₐₓ)≈(mᵢ/mₑ)^{1/8}×τₑ or 2.6×τₑ for Eᵢ=Eₑ and mᵢ/mₑ=1836,

where νₑ is electron velocity for an energy of Eₑ, Bₘₐₓ is the peak magnetic field strength at the cusp points, and R_{system} is the cusp confinement system radius, Eᵢ is the ion energy, mᵢ/mₑ is the mass ratio between proton and electron, M* is an effective mirror ratio defined by Bₘₐₓ/B*ₘᵢₙ, B*ₘᵢₙ is the magnetic field strength where the electron starts attaching to the magnetic field lines when the magnetic field gradient scale length is comparable to the gyroradius as determined by

$$\frac{1}{B} \times \frac{d B}{d r} ( r = {r}_{adibatic} ) = \frac{1}{A \times {r}^{gyro} ( {E}_{e} , {B}_{min}^{*} ( r = {r}_{adibatic} ) )}$$

where r_{adiabatic} is the radial location of the electron attachment to the magnetic field lines and r^{gyro} is the particle gyroradius for the electron, e, or ion, i, as given by r_{e,i}^{gyro}=m_{e,i}*ν_{e,i}/(eB), and A is a numerical constant between 3-6 for a given magnetic field profile.

Equation 2 shows the challenges related to the plasma start up to produce a high beta plasma in the magnetic cusp system and to achieve the conjectured good electron confinement as described in Equation 1 using electron beam injection. These challenges may be appreciated by examining the needed input electron beam power to approach high beta plasma densities for a fusion reactor. For 50 keV electrons in 5 T cusp magnetic fields, the required electron density to reach β=1 condition is 1.2×10¹⁵ cm⁻³, ignoring ion pressure for simplicity. Assuming that the electron beam density in the cusp system in FIG. 2 has reached 1×10¹³ cm⁻³, or 1% of the needed density to reach β=1 condition, a required input electron beam power to sustain this density of 1×10¹³ cm⁻³ will be about 200 GW with an electron confinement time of only 1 μs according to Equation 2.

The above calculation demonstrates why there has been no experimental work that validates the electron confinement described in Equation 1 utilizing electron beam injection. It is noted that experimental results by Krall et al in 1995 is consistent with the simple estimate in Equation 2 [16], where the observed electron density reached only 1×10⁹ cm⁻³ for an electron injection power of 80 kW at 8 kV beam energy in a 6 coil cusp configuration.

In the calculation above, the criteria use β=1 has been chosen with the following choice of values for the plasma pressure and the magnetic pressure for the purpose of calculation. The value of plasma pressure is an average plasma pressure in the confined plasma volume inside the cusp. The value of magnetic pressure is (B_{cusp}²/2μₒ) with B_{cusp} is the magnetic field strength at the cusp points in vacuum. It is noted that β=1 criteria is not an absolute requirement but more of a guideline. Any substantial β value comparable to 1 may be sufficient to generate the necessary plasma condition to produce good electron confinement. For example, β may be chosen within the range of 0.1 to 10.0, or may be chosen within the more preferable ranges of 0.2-5.0, 0.3-3.0, 0.5-2.0, 0.7-1.5, 0.8-1.2, 0.9-1.1 or most preferably, β may be set to be approximately equal to or equal to 1. It is note that the confined plasma pressure of nₚk_{B}T is related to the stored energy in the plasma, W_{stored}, by the confinement volume,

$$\frac{4 π}{3} {R}_{system}^{3} ,$$

as in

### Equation 3:

Equation 3: Stored energy of the plasma in the cusp confinement system with a radius of R_{system} and cusp magnetic field B_{cusp}

$${W}_{stored} = \frac{4 π}{3} {R}_{system}^{3} {n}_{p} {k}_{B} T = \frac{4 π}{3} {R}_{system}^{3} \frac{{B}_{cusp}^{2}}{2 {μ}_{0}} β .$$

Equation 3 may be used to provide estimates of the input energy of the plasma initiator for various starting conditions of cusp magnetic field, B_{cusp}, cusp confinement radius R_{system} and required β value to produce good electron confinement. In most plasma systems, the ion and electron density is equal and the plasma density, nₚ, is used for either ion or electron density. One may start with the cusp confinement system radius R_{system} and B_{cusp} values based on the physical dimensions of the plasma chamber and B field generating equipment. The cusp magnetic field strength (i.e., the magnetic field generated by the coil system) may be in the range of 0.5-20 Tesla in the cusp point and more preferably within the range of any one of 1-15, 3-12, 4-10, or 5-8 Tesla In addition, β may be chosen within the range of 0.1 to 10.0, or may be chosen within the more preferable ranges of 0.2-5.0, 0.3-3.0, 0.5-2.0, 0.7-1.5, 0.8-1.2, 0.9-1.1 or most preferably, β may be set to be approximately equal to or equal to 1. Equation 3 then gives the minimum energy needed for the plasma initiator (e.g., injector). It is noted that the efficiency of plasma injector is less than 100% and as such, the required input energy of the plasma initiator is likely to be larger than the minimum energy given in Equation 3. In practice, one may choose a plasma initiator (e.g., injector) energy range of 0.5-50 times the value of the stored energy given by Equation 3, or a more preferably ranges of 0.5-30, 0.5-10, 1-30, 1-20, 1-10, 5-30, 5-20, and 5-10.

For embodiments of the present invention, various plasma injectors as a start-up device are utilized. The benefit of low temperature plasma injection, compared to high energy electron beam injection, is apparent in Equation 2. First, the confinement time of injected particles increases with decreases in particle energy. For example, the electron energy confinement time is approximately 0.5 ms for 50 eV injection energy compared to 1 μs for 50 keV injection energy for the device in FIG. 2. As such one may choose a temperature of the plasma electrons of a plasma initiator (e.g., injector) in the range of 5-1000 eV, or more preferably ranges of 10-500 eV, 10-100 eV, 20 eV-250 eV, 50 eV-300 eV, 50 eV-500 eV, and 100 eV-1000 eV. It is noted that electron and ion temperature tends to equilibrate relatively quickly due to frequent collision when the temperature is low and the density is relatively high in the injector. For 1 T cusp B-field, β=1 condition yields nₚ=2.5×10¹⁶ cm⁻³ for 100 eV plasma injection, where the time to equilibrate electron and ion temperature is only 1.3 μs. Second, embodiments of the present invention utilizes rapid and high power plasma injection. The time scale of the injection (or more generally, the initial high density plasma formation) is on the order of or comparable to the electron confinement time τₑ of Equation 2. The short pulse duration limits the loss of plasma and improves the efficiency of producing a high beta plasma. Furthermore, the plasma injector should operate with sufficiently high input energy (as per Equation 3) to produce the initial plasma that can reach the desired β state.

As examples of the pulse duration for the plasma initiator of embodiments of the invention, the maximum useful pulse duration may be a multiple of electron confinement time in Equation 2. For example, the maximum pulse duration can be between 0.1 and 20 times the electron confinement time of Equation 2 and more preferably 0.3-3, 0.5-5, 1-3, 3-10, 5-20 times the electron confinement time of Equation 2. An optimum pulse duration will be subject to various types of plasma initiators and specific cusp configurations. Although it is possible to use the plasma initiator with a longer pulse than 10 times the electron confinement time of Equation 2, the efficiency of plasma initiator (e.g., injector) will decrease accordingly. In addition, plasma initiators with a shorter pulse duration than 0.1 times the electron confinement time of Equation 2 can be utilized for embodiments of the present invention. For example, the plasma initiator consists of a wire pinch array (e.g. with 50 individual pinches) can operate with a overall pulse duration approximately equal to the confinement time of Equation 2, while an individual wire pinch can has a much shorter pulse duration. In addition, another plasma injector can be a plasma generated using a short pulse, high power laser. The pulse duration of the high power laser can be very small, compared to the electron confinement time of Equation 2.

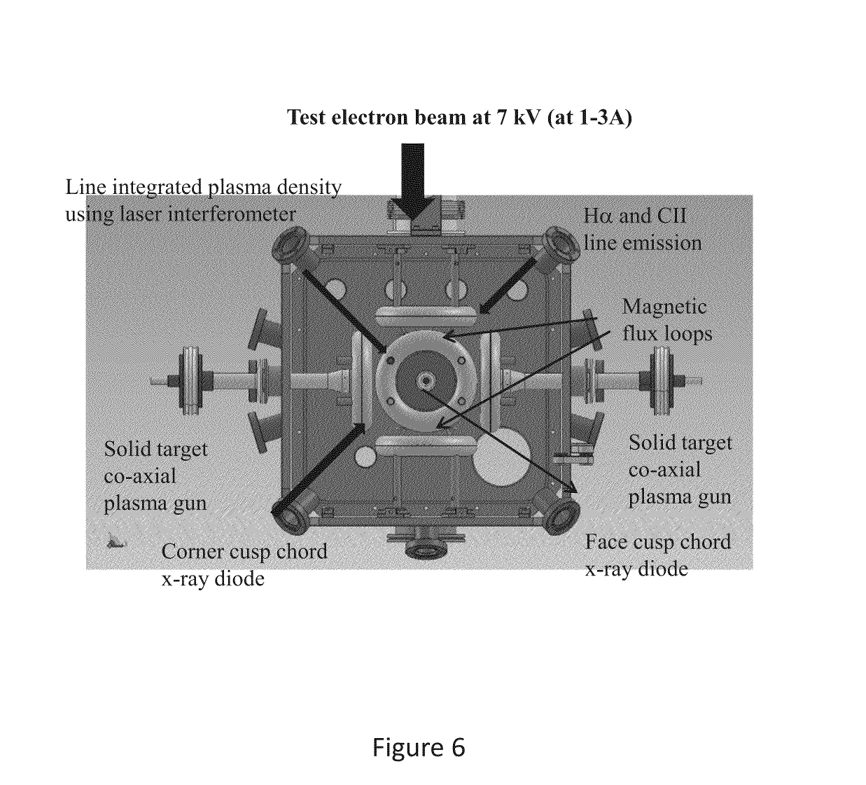

FIG. 6 shows the experimental test system that was constructed and operated to validate the start up scheme in accordance with embodiments of the present invention. The system consists of 6 coil cusp system with the magnetic field variable from 0.7 kG to 2.7 kG at the cusp location. The size of coil is 6.9 cm of major radius and 1.3 cm of minor radius with 21.6 cm linear spacing between two opposing coils, resulting in a cusp confinement system radius of 11 cm. For a cusp magnetic field of 2.7 kG, the β=1 plasma condition requires the stored energy in the 11 cm radius plasma to be ˜160 J in the system. For a 10 eV injection energy, Equation 2 leads an estimated electron confinement time of 7 μs. The plasma injector needs to deliver 160 J of energy into the plasma in the cusp during a pulse duration of 7 μs, corresponding to an input power in the 23 MW range.

There is a minimum electron temperature for the plasma injector in accordance with embodiments of the invention. This is because the underlying physics process that contributes to a sharp magnetic field boundary is electron diamagnetism [2, 7, 8, 9]. In order to utilize electron diamagnetism, electrons should not undergo so many collisions that could prevent electrons from completing at least one gyro-motion in a given magnetic field. Equation 4 shows this condition.

Equation 4: Electron magnetization condition

ω_{ce}=eB/mₑc≧A×νₑ=A×2.9×10⁻⁶nₑλTₑ^{-3/2}

where ω_{ce} is electron gyrofrequency, e is electron charge, B is magnetic field strength, mₑ is the electron mass, c is the speed of light, A is a numerical constant between 0.25-5.0 depending on magnetic field configuration and plasma parameters, νₑ is electron collision rate, nₑ is electron density in the cusp confinement system from plasma injection, λ is the Coulomb logarithm (typically ˜10), and Tₑ is electron temperature.

Equation 4 determines the minimum electron injection temperature that can be used in accordance with embodiments of the present invention. It is noted that for the system shown in FIG. 6 with a 2.7 kGauss magnetic field, the electron gyrofrequency, ω_{ce} is 4.8×10¹⁰ rad/s, compared to the electron collision rate νₑ of 1.6×10¹⁰/s for β=1 plasma condition with 10 eV electron temperature and 1.8×10¹⁶ cm⁻³ electron density, thus satisfying criteria given in Equation 4. Equation 4 can also be used to determine the minimum B field needed for embodiments of the present invention. If the B field is insufficient, the plasma will be highly collisional and will not produce the diamagnetic effects needed to form the sharp magnetic field boundaries needed for electron beam confinement.

Finally, there is an issue of neutral plasma injection compared to non-neutral single species injection. Bussard had proposed electron beam injection to produce a deep potential well in the cusp magnetic fields. Typically, it is difficult to achieve the high plasma density that is required to fulfill the high beta condition condition (i.e. such as β=1) with injection of purely single species plasma using an electron beam or ion beam. As such, embodiments of the present invention employ an injection scheme that utilizes a neutral plasma injector with approximately equal and large number of electrons and ions simultaneously to create high beta plasma in the cusp filed configuration.

Representative and non-limiting examples of plasma injectors that can meet the criteria given in accordance with embodiments of the present invention include: 1) A co-axial or linear plasma injector, 2) plasma injector based on field reversed configuration (FRC) and spheromak, 3) in-situ plasma formation using laser produced plasmas with gas, liquid droplet or solid target, and 4) in-situ plasma formation using high current pinch in a various arrangement. The examples of pinch system are: 1) a single wire pinch, 2) wire array pinch, 3) pinch using liquid droplet or microparticles, 4) pinch using gas jet, and 5) combination of various pinches. In addition, if multiple pinches are used to form plasma injector, the entire pinch system can operate in a single pulse or series of pulses for each pinch element within an overall pulse duration equal to the electron confinement time given in Equation 2. The plasma initiator can operate with either a gas or solid target of various materials. In general, it is preferred to operate the plasma initiator with the plasma forming materials using only the proposed fusion fuels. For example, in the case of D-T fusion fuel, the preferred plasma forming material will be deuterium and or tritium gas, cryogenic liquid or cryogenic solid. However, it is acceptable to use other materials such as hydrocarbons and metals either as mixtures or compound.

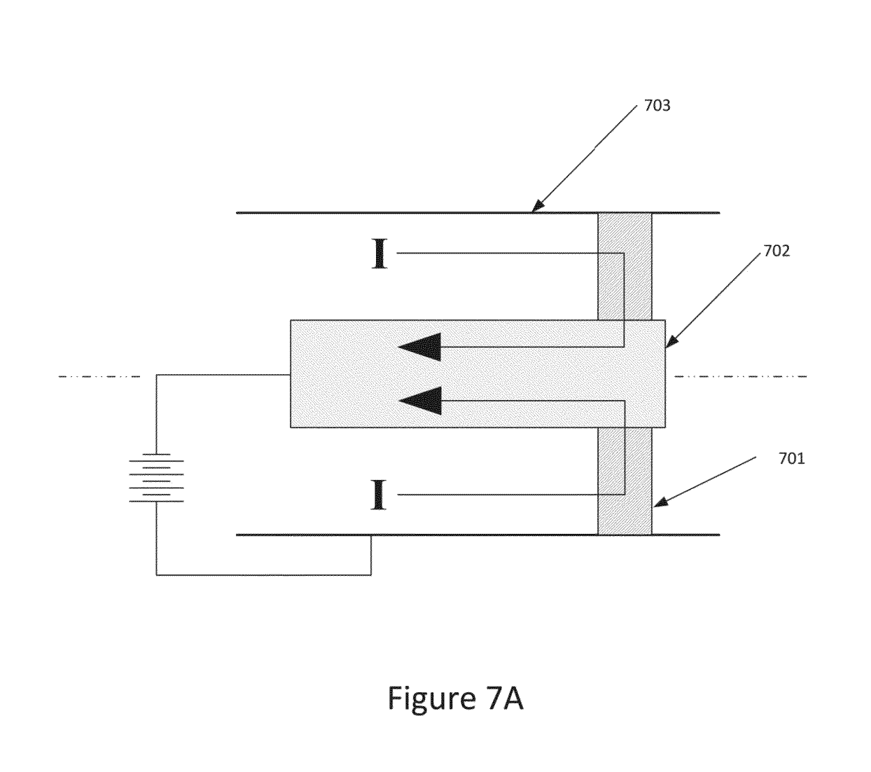

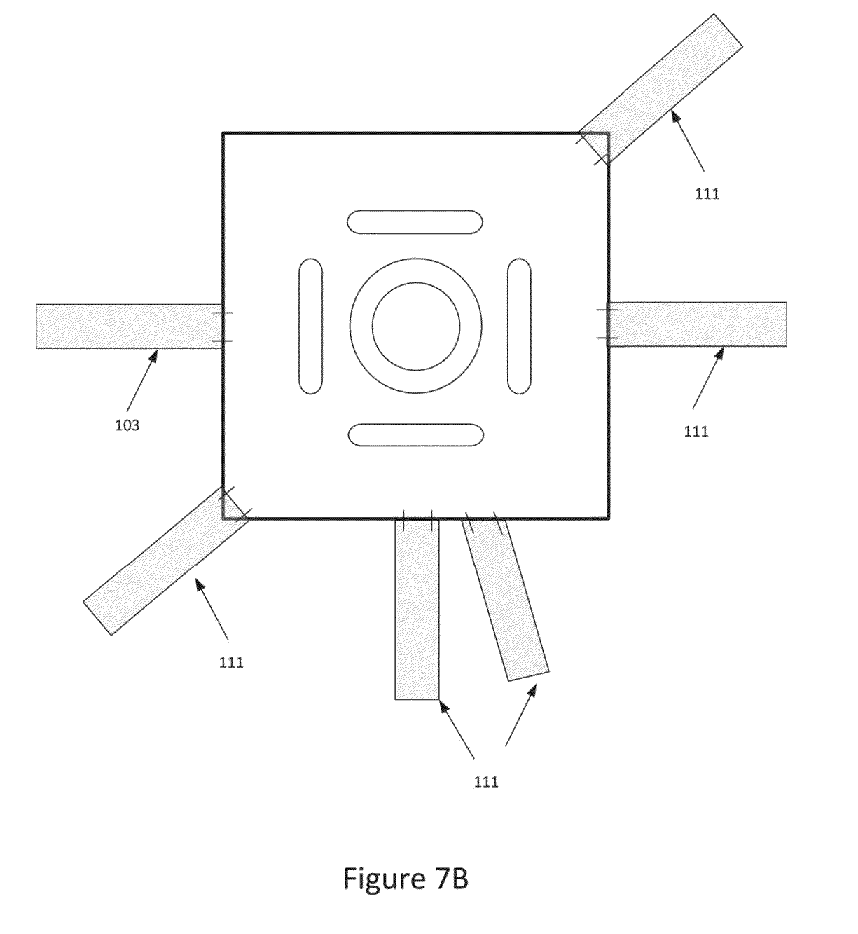

A co-axial plasma injector, as shown in FIG. 7A, is one of the most common high power compact plasma injectors currently available, consisting of target material 701, a central cathode 702 and an outer anode 703. Intense electrical currents between a cathode and an anode turn the target materials into a plasma. The key operating principle of the plasma injector for a co-axial or linear geometry is the j×B force from the plasmas current to expel high density plasmas outward (to the right in FIG. 7A) at a rapid speed, based on the originally invention by Marshall at Los Alamos National Laboratory [5]. The plasma injector can operate with either a gas or solid target of various materials In accordance with embodiments of the invention, co-axial plasma injectors with a solid target, as shown in FIG. 7A, was constructed to validate the start-up criteria to achieve good electron confinement as described in Equation 1. Other plasma injectors could alternatively be used as for example a field reversed configuration (FRC) and spheromaks These injectors are high power plasma injectors, capable of producing high pressure plasma, with sufficiently high plasma density in excess of 1×10¹⁴ cm⁻³ and plasma temperatures of 50 eV or higher. These operating parameters of FRC and spheromaks are attractive since they can be used to initiate a small to medium size magnetic cusp configuration. It is noted that for a plasma injector (e.g., gun), FRC or spheromak, one injector 103 may be sufficient to meet the high beta plasma start up requirement or one or more of additional plasma injectors 111 can be utilized as shown in FIG. 7B either in the cusp axis or off-axis location.

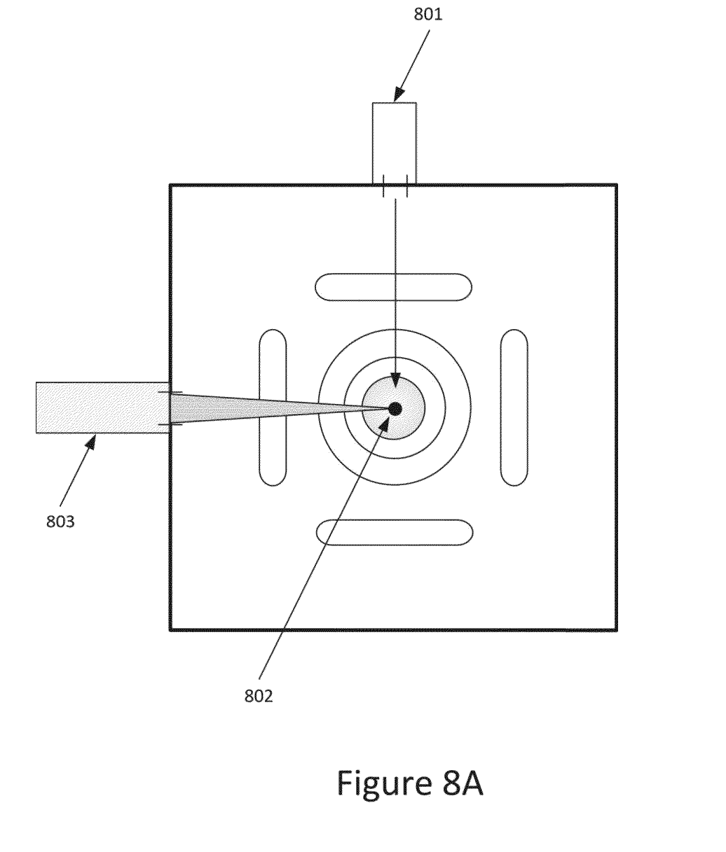

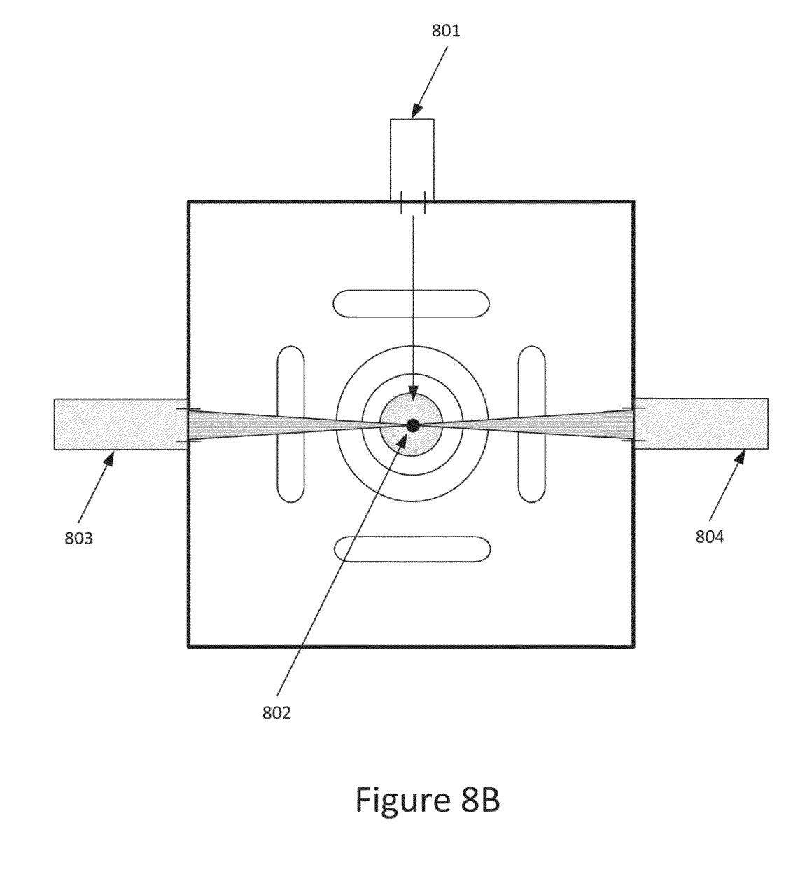

The laser plasma injector is also a suitable plasma system that can be used in embodiments of the present invention as shown in FIGS. 8A and 8B. In FIGS. 8A and 8B, a laser target delivery system 801 introduced a small target of solid, liquid or pressurized gas 802 into the chamber. The target is then ionized and heated up to sufficiently high plasma temperature with the use of a high power laser 803 as shown in FIG. 8A or multiple high power lasers 803 and 804 as shown in FIG. 8B. For multiple lasers, the lasers may have equal or different wavelengths. In 1980, Pechacek and his co-workers at the Naval Research Laboratory had successfully produced β=1 plasmas in the axis symmetric spindle cusp using a combination of a laser and a CO₂ laser to ionize a solid deuterium pellet in 1.5 kG gauss cusp fields [9]. The lasers produced a plasma with 15 eV of electron temperature and electron density in the range of 1-1.5×10¹⁵ cm⁻³. With the technology advance associated with laser driven inertial confinement fusion research such as National Ignition Facility at Lawrence Livermore National Laboratory, there are many different types of lasers which can be utilized to produce the initial plasma that has the high density and sufficient temperature, required for embodiments of the invention.

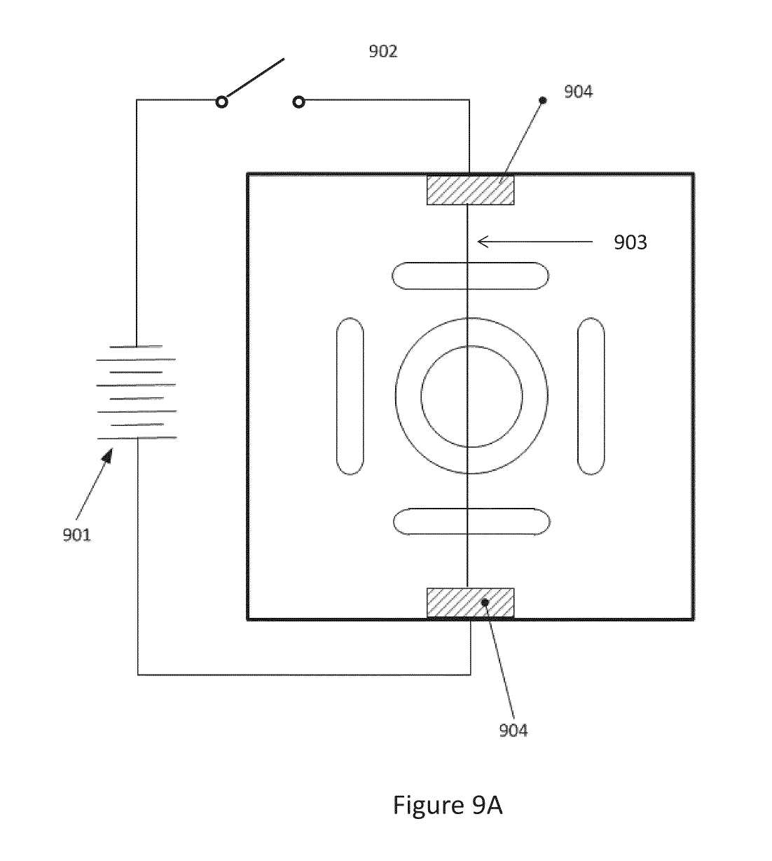

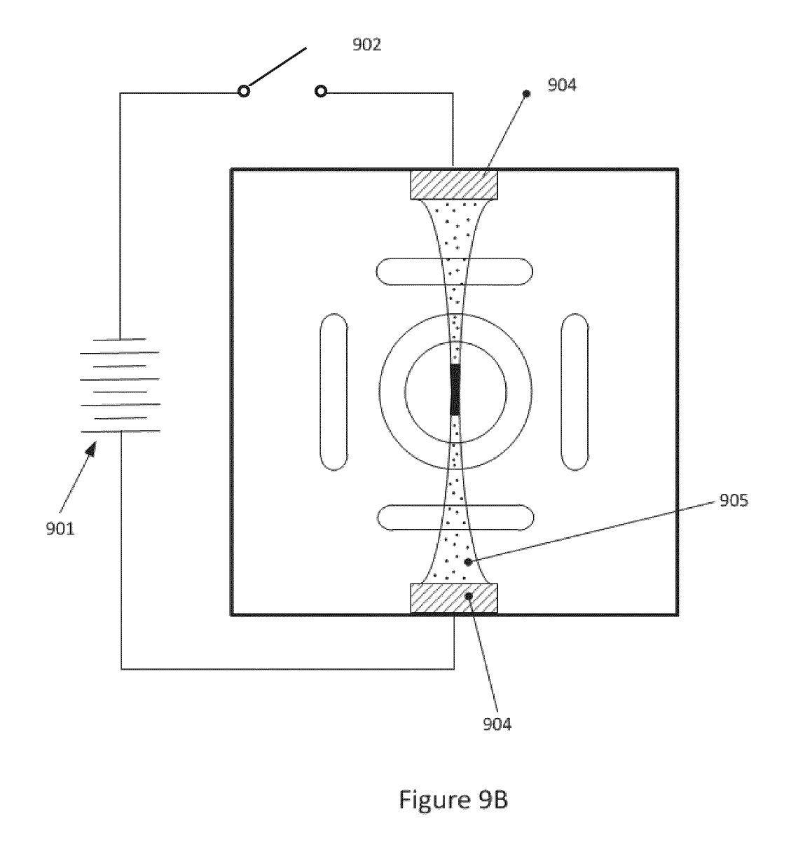

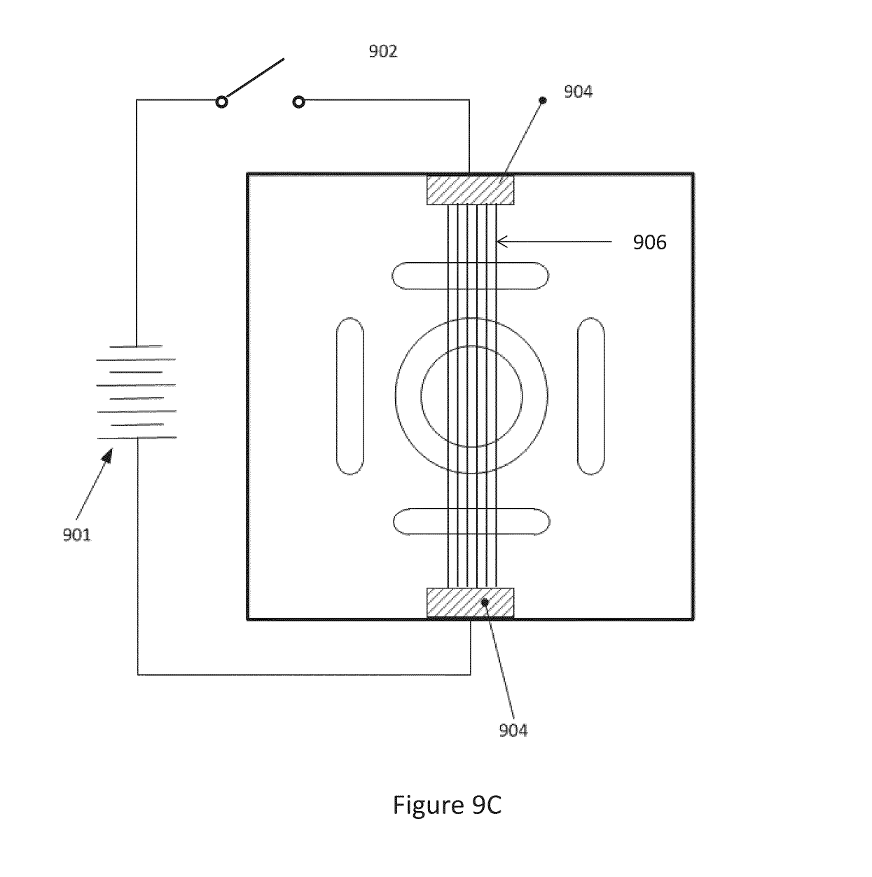

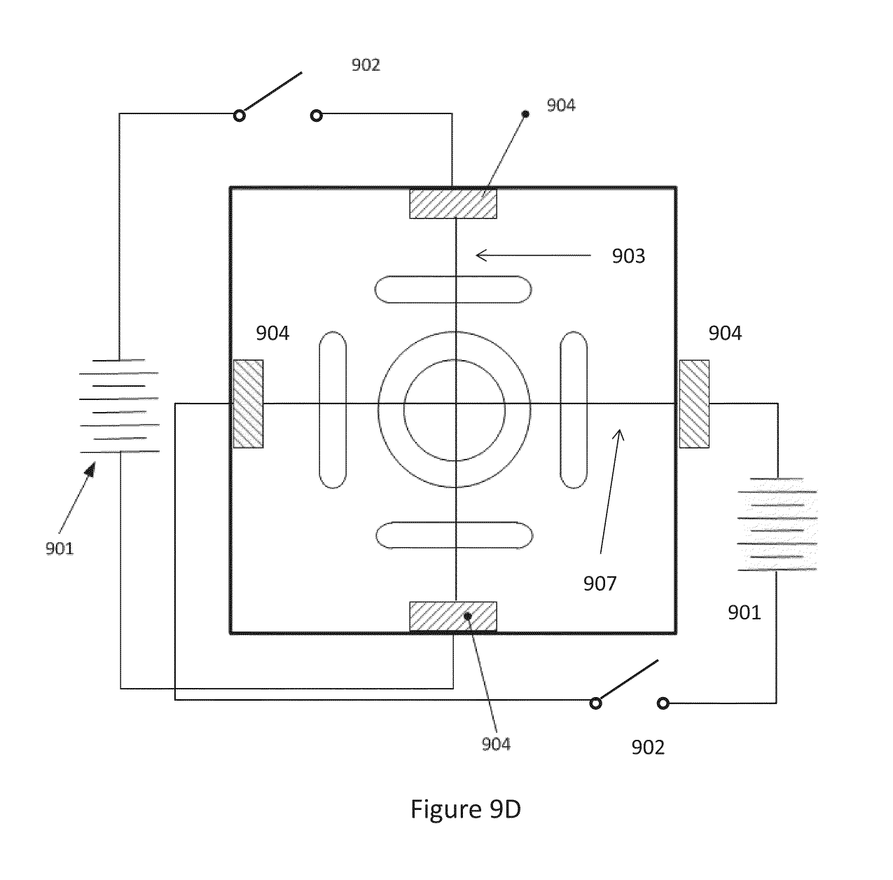

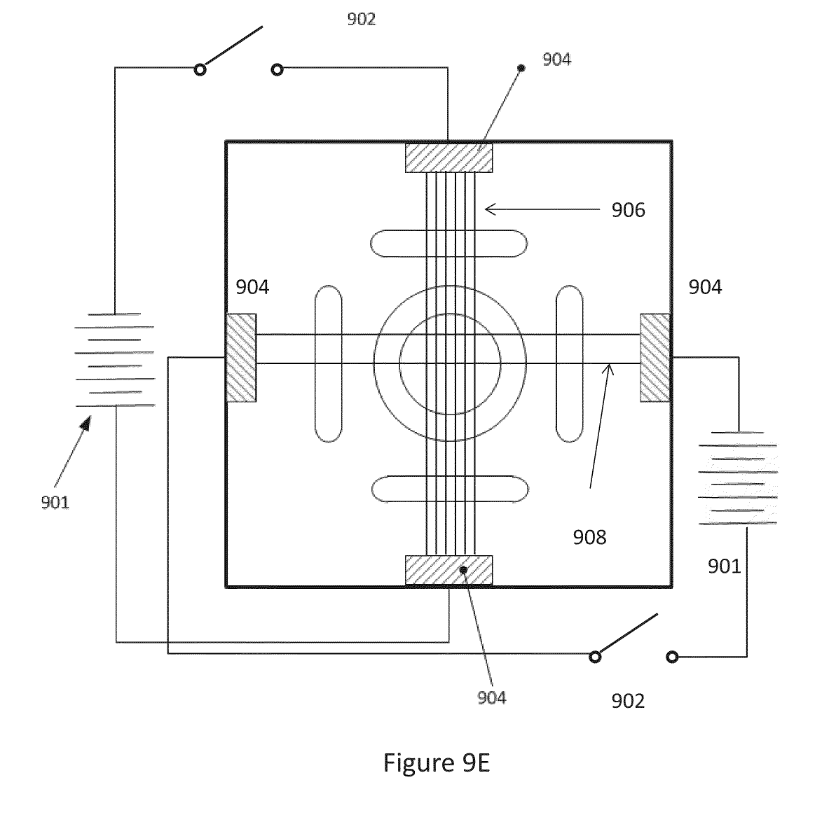

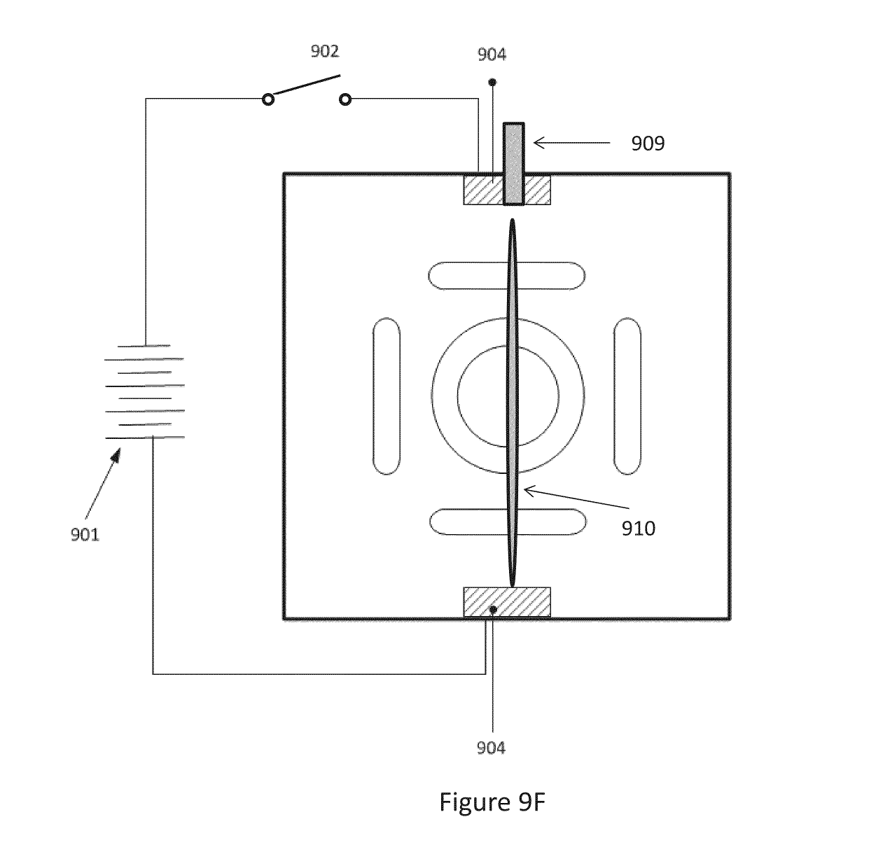

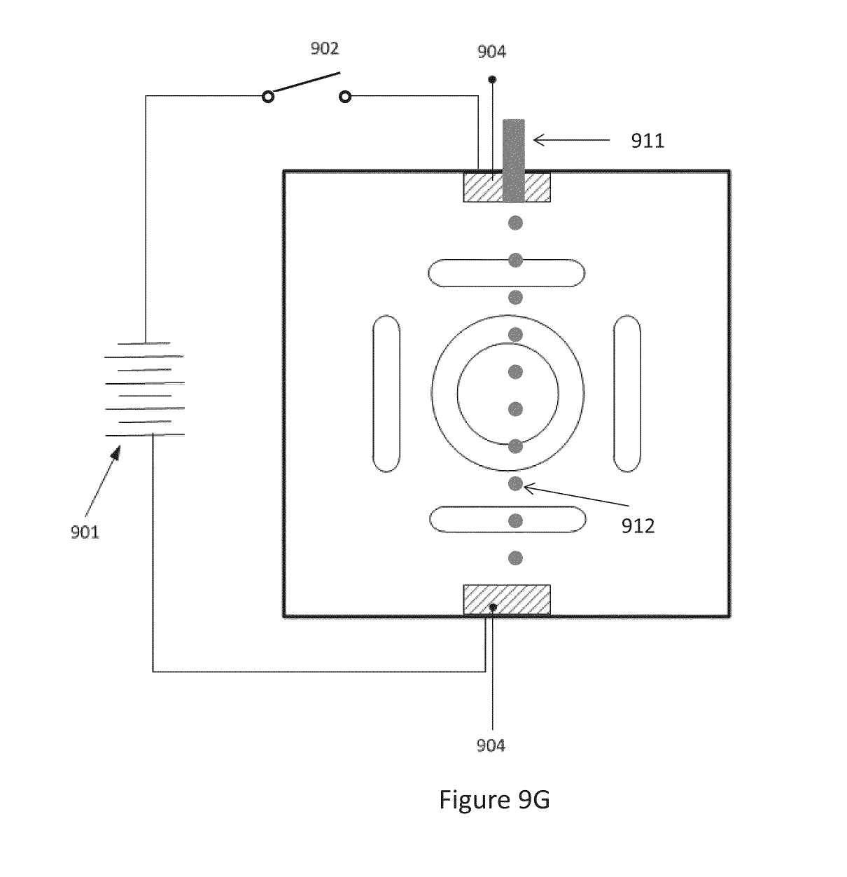

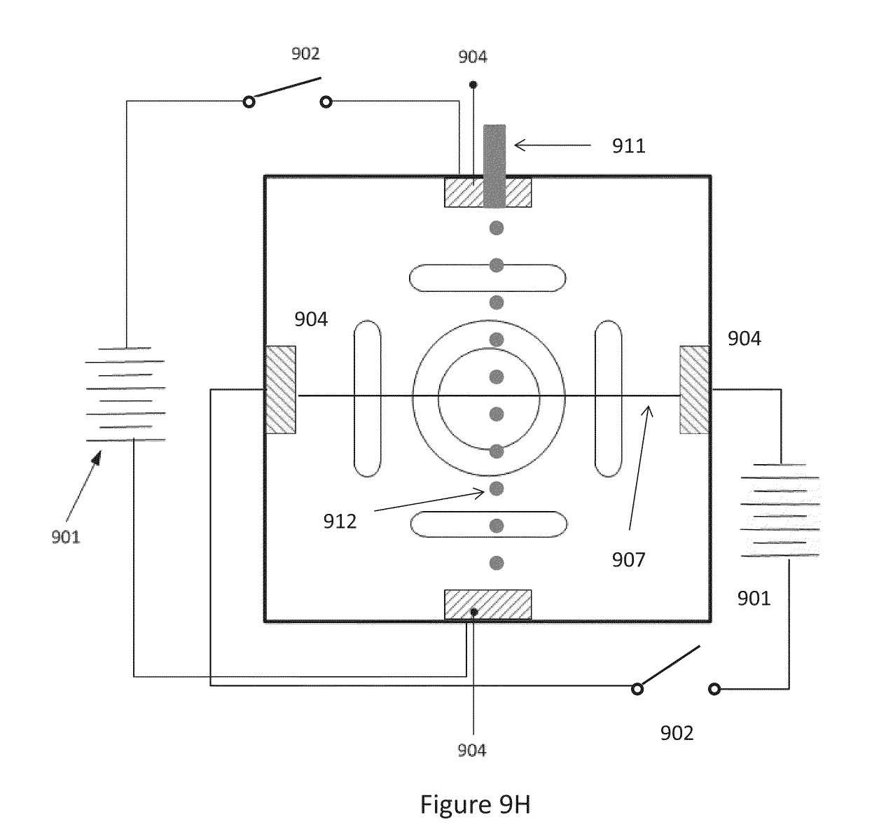

A high current pinch is another example of a plasma initiator that can be used in the current invention. The pinch produces a high pressure plasma by flowing a large current through the materials. FIG. 9A through 9H show various configurations of pinches that can be used as plasma initiators where like numbers represent like parts. Electrical energy is stored in the capacitors or batteries 901. The pinch is formed when the switch or switches 902 are activated (closed) and the electrical current is passed through a plasma forming material 903 that is in contact with the electrodes 904. By adjusting the pulse duration of the current, sufficiently high pressure plasma can be produced that meets all the plasma initiator criteria in accordance with embodiments of the invention. Since the plasma stability is governed by the cusp magnetic fields, the stability of pinch is of no concern. As such, one or more pinches can be used to create initial high pressure plasma, since the plasma initiation performance should not degrade if multiple pinches or off-axis placements of pinches are used.

FIG. 9A, shows a single linear pinch configuration utilizing a solid column or wire of plasma forming materials 903. In FIG. 9B, the plasma forming materials 905 can be shaped to improve the pinch operation. The pinch plasma generator has a reaction chamber, plasma electrodes 904 and a plasma forming material 905 in a tailored configuration having a larger area adjacent the electrodes and a smaller area in the center of the reaction chamber. By shaping the target materials, the plasma can start in the central region inside the magnetic cusp fields where the current density is highest and the target material thickness is smallest. Once started, the central plasma will expand and accelerate further plasma formation along the solid column. In FIG. 9C, more than one columns (e.g., wires) of plasma forming materials 906 are used for pinch operation as plasma initiators in order to produce high beta plasma. Each column can be straight or shaped, as for example in FIG. 9B, to optimize the plasma initiator operation. In FIG. 9D, two or more sets of electrodes 904 are used to form multiple pinches using plasma forming materials 903 and 907 inside the cusp system. Each pinch can have its own energy storage 901 and its own electrical switch 902. They can operate simultaneously or in sequence. If they operate in sequence, the pulse duration of the plasma initiator is measured between the beginning of the 1^{st} pinch and the end of the last pinch. In FIG. 9E, multiple columns of plasma forming materials are used for two or more sets of electrodes to form multiple pinches with the multiple plasma forming materials 906 and 908 as plasma initiators. In FIG. 9F, a pinch is produced using collimated gas jet 910 from gas injector 909. In FIG. 9G, a pinch is produced using either liquid droplets or microscale particulates 912 from the appropriate liquid or particle injector 911. Various combinations of different pinch systems can be used as plasma initiators, as shown in FIG. 9H.

In accordance with other embodiments, one may combine different types of plasma initiators to achieve the desired high beta conditions within the plasma confinement region. In accordance with some embodiments, any one of the described pinch initiators may be combined with one or more of an injector gun (e.g., co-axial plasma injectors), FRC and laser. Further, one or more of the gun, FRC and laser may be used to provide initial energy to the cusp confinement region and any one of the described pinch initiators may then be used to subsequently augment the energy produced in the confinement region to the required high beta values desired.

All of the plasma injectors that are described above are capable of producing a high pressure plasma to meet, for example, β=1 condition during a pulse duration given in Equation 2. It is noted that the list is not meant to be a complete list as any plasma injector can be used as long as it meets the above criteria. It is further noted that while the term “injector” is utilized herein to describe the various types of plasma devices for forming the plasma, some of these devices do not literally “inject” plasma from the external plasma chamber (vacuum chamber 101 of FIG. 4) to inside the chamber, but rather form the plasma “in situ”. The laser device of FIGS. 8A and 8B is an example in which the high power laser is directed toward the target which is positioned within the vacuum chamber and the target is ionized by the laser to form the plasma within the chamber, i.e., in situ. The current pinch plasma devices of FIG. 9A through FIG. 9H are further examples of in situ plasma formation wherein the plasma is formed internally to the vacuum chamber and not formed outside the chamber and transported (injected) to the interior of the vacuum chamber. The term injector has been used herein to describe both internally generated and externally generated plasmas. However, to make the term clearer in the appended claims, the term “plasma initiator” (or “initiating” when used as part of a method claim) is utilized to indicate a device or method step that forms a plasma within the vacuum chamber either by in situ formation within the chamber or by transport (injection) of externally formed plasma into the central region of the chamber.

Electron Beam Injection after Plasma Start Up

The next step in accordance with embodiments of the present invention is the use of an electron beam injector [104] or multiple electron injectors to produce a deep negative potential well for ion acceleration and confinement after the high pressure plasma in the cusp greatly improves the high energy electron confinement. The electron beam may be pulsed or pulsed with a DC offset (e.g. 50 MW) so that it modulates around the offset. The electron beam may also operate continuously (e.g., sustained at 50 MW). In either case, the electron beam is utilized to form the potential well that accelerates and confines the ions in the magnetic cusp plasma region. The confinement is applicable both to the plasma formed from the initiator as well as the plasma later introduced by the fusion fuel injector.

Electron beam injection can produce excess electrons in the previously neutral plasma device. The excess electrons in the system then form an electrostatic potential well and via Coulomb attraction, provide ion acceleration. Ions in the system will gain kinetic energy from the electric field in the potential well as they converge toward the center, while giving up the acquired kinetic energy as they move outward toward the coils and cusp boundary. If the potential well is sufficiently deep, on the order of 10 keV or higher, the ions will have sufficient energy to generation fusion reaction near the center at a significant rate. More generally, the electron injection may produce a potential well with the electron beam energy in one of the ranges of 10-1000 keV, 10-200 keV, 25-150 keV, 50-300 keV, 75-500 keV and, 100-1000 keV. The same potential well will affect the initial electrons from the plasma initiator during a start up differently. These electrons will lose their kinetic energy to the electric field in the potential well as they converge toward the center. On the other hand, an electron will gain energy as it moves outward toward the coils and the cusp boundary, which increases its probability of leaving the magnetic cusp system based on Equation 1. In fact, the goal of the electron beam injection is to remove initial electrons from the plasma injector and to replace them with high energy beam electrons over time. This is because the maximum potential well that can be produced in the dense high pressure plasma is comparable to the average energy of electrons in the system due to the plasma shielding effect, known as “Debye” shielding. In order to produce a deep potential well of more than 10 keV for a fusion reactor, it is essential to replace the initial electron from the initial plasma injection, typically have energies in the range of 5-1000 eV with the high energy electron beam operating at 10 keV or higher.

One can provide an estimate of the required electron beam power to achieve a deep potential well for the system shown in FIG. 4. For 50 keV electrons in 5 T cusp magnetic fields, the required electron density to reach β=1 condition is 1.2×10¹⁵ cm⁻³. It is noted that ion pressure is automatically reduced to a very small value because ions will lose their kinetic energy as they move toward the coils and the cusp boundary. The confinement time for 50 keV electrons given in Equation 1 is 0.13 seconds. A simple zero dimensional particle balance yields an electron injection current of 3300 Amperes to sustain an electron density of 1.2×10¹⁵ cm⁻³ over the plasma sphere (cusp confinement system radius) of 80 cm radius. This corresponds to an electron beam power of 165 MW, a large but manageable input power. It is noted that in the presence of a deep potential well, the electron confinement time in Equation 1 can be increased due to the slower speed of the beam electrons inside the potential well, thus reducing the electron beam power requirement. The potential well also plays a role in reducing ion loss. According to Equation 1, the loss of ions will be inherently higher than that of electrons due to their large gyroradius when a sharp magnetic field boundary is established in the cusp configuration, which was experimentally validated by Pechacek in 1980 [9]. In accordance with embodiments of the invention, this ion loss does not take place because of the potential well. Ions will lose their kinetic energy as they move away from the potential well and toward the cusp openings. As a result, they will have smaller gyroradius, which reduces the ion loss rate based on Equation 1. Separately, the use of one or more electron beams to form the potential well rather than using physical electrodes eliminates the need for the high voltage bias on the coil case and simplifies the structural construction of coils.

Validation of Enhanced Electron Beam Confinement from High β Plasma in the Magnetic Cusp Configuration

Embodiments of the invention use a high power plasma injector to form high β plasma in the cusp to improve plasma confinement, and use an e-beam to produce a deep potential well within the plasma, so ions in the plasmas can gain energy from the electron beam and produce fusion reactions

FIG. 6 show an experimental system in accordance with the principles of embodiments of the invention. The experimental set up of FIG. 6 was developed to experimentally demonstrate enhanced electron confinement as a first step. This enhanced confinement results from the creation of a sharp boundary between the high beta plasma and the surrounding magnetic field and is a high β condition essentially described by Equation 1.

The system of FIG. 6 operates with a 6 coil cusp configuration producing 2.7 kG of magnetic field at the cusp points. The plasma injectors consist of two co-axial plasma injectors each using a solid polypropylene film of 4 μm thickness. These solid polypropylene films form the target material 701 of FIG. 7. Each plasma injector is powered by a high voltage capacitor and operates with 60-160 kA of gun current and up to 500 MW of input power for 5-10 μs. Based on laser interferometer data, the injectors are capable of producing 1-2×10¹⁶ cm⁻³ plasmas with an electron temperature of 10 eV estimated from the C II and C III line emission. In addition, two magnetic flux loops are installed near the coil location to measure the diamagnetic property of high β plasma in the cusp system. The electron beam injector is based on LaB₆ thermionic emitter and produces 1-3 A of electron current at 7 kV beam energy. The electron beam injector was constructed to monitor the high energy electron confinement property in the cusp system and to validate the confinement enhancement shown in Equation. 1. However, this electron injector was not sufficiently powerful to provide sustainment of high beta state in the cusp or to produce a negative potential well for ion acceleration.

The concentration of the high energy electron beam was measured using two x-ray diodes, one viewing the central plasma through the cusp opening in the face of coil and the other viewing the central plasma through the cusp opening in the corner of coils. The high energy electrons from the beam can generate x-rays via bremsstrahlung when they are in close proximity to the ions in the injected plasma. Since the beam injection energy is sufficiently high at 7 kV, the x-ray emissions from bremsstrahlung can be emitted in a hard x-ray spectrum between 2 kV and 7 kV photons. Though the electron beam induced bremsstrahlung can be measured at lower photon energy below 2 kV, the photon energy range between 2-7 kV is chosen for the experimental set-up of FIG. 6 because there is no other source of x-rays in this spectrum beside electron beam induced bremsstrahlung. Both detectors were fitted with collimators and high energy x-ray filters to measure only the hard x-ray emission from the plasma above 2 kV photon energy. In addition, all metal surfaces in the line of sight from the x-ray diodes are covered with plastic materials to suppress x-ray emission above 2 kV. As such, the x-ray diode signal was proportional to the beam electron concentration and the plasma ion concentration from the plasma injectors based on the well know bremsstrahlung emission formula, as shown in Equation 5.

Equation 5: Bremsstrahlung emissivity formula

$${P}_{br} = 1.69 \times {10}^{- 32} \times {{n}_{e}^{beam} ( {E}_{e}^{beam} )}^{1 / 2} {\sum }_{Z} {Z}^{2} {n}_{i} ( Z ) \approx 1.69 \times {10}^{- 32} \times {n}_{e}^{beam} {{n}_{e}^{plasma} ( {E}_{e}^{beam} )}^{1 / 2}$$

where P_{br} is the bremsstrahlung emission power, nₑ^{beam} is the electron beam density, Eₑ^{beam} is the electron beam energy, Z is the charge state of ions and nᵢ(Z) is the ion density at the charge state Z, and the summation takes place over Z=1, 2, 3, . . . to the maximum ion charge state. For the present demonstration experiments, we can simplify the Equation 5 by limiting the maximum ion charge state to 1 and replace

$${\sum }_{Z} {Z}^{2} {n}_{i}$$

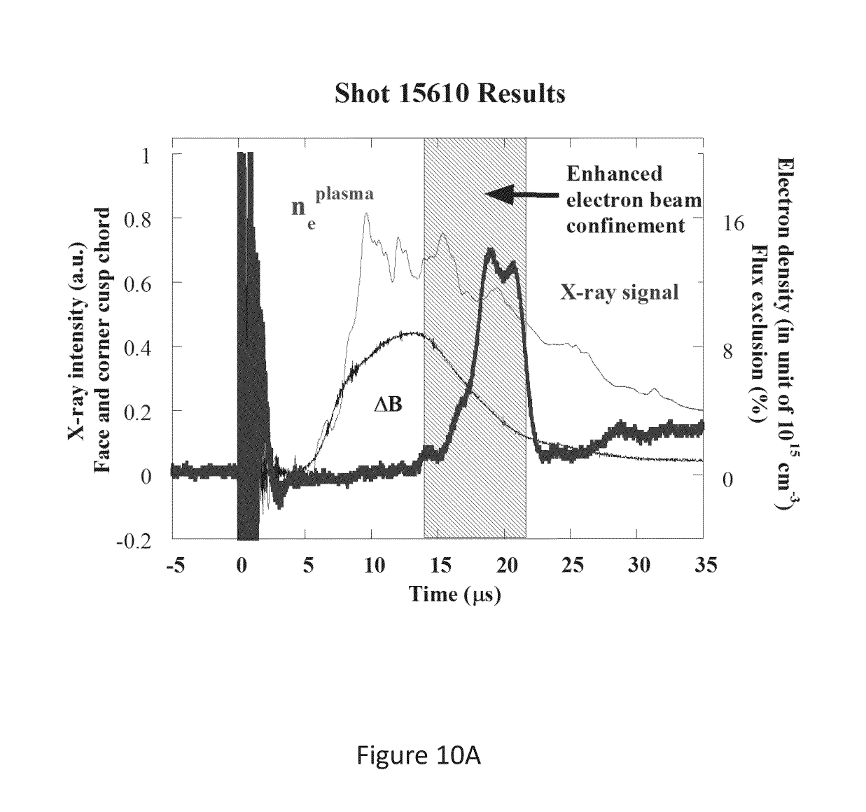

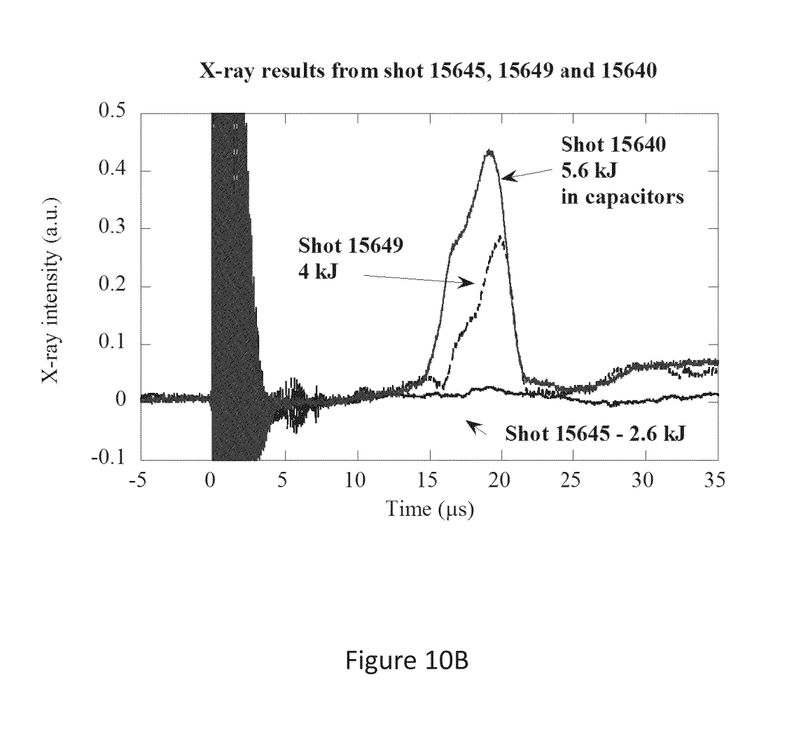

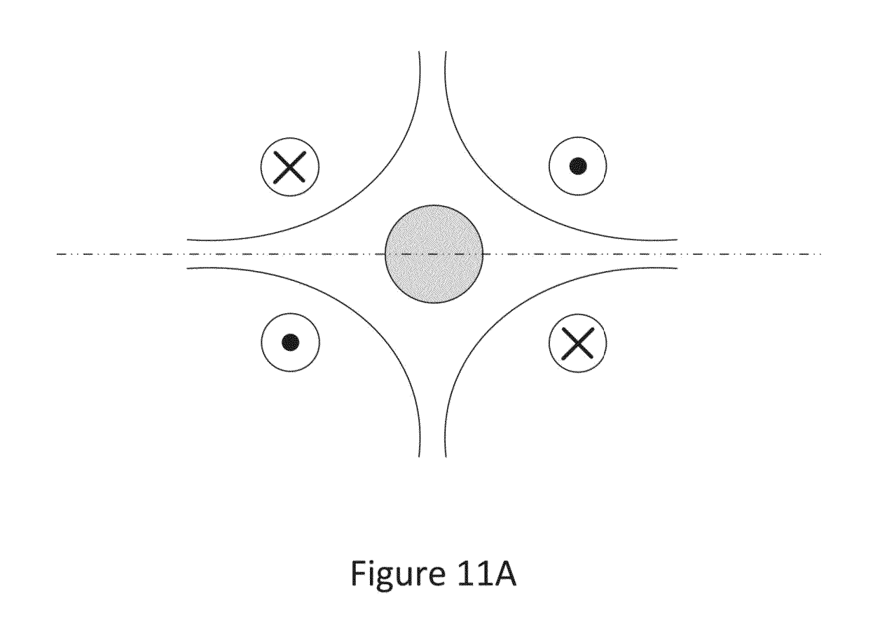

with nₑ^{plasma}, where nₑ^{plasma} is the plasma electron density producing high beta state in the cusp. This simplification is possible because the plasma temperature is relatively low at around 10 eV, estimated from visible spectroscopy and most of ions are only singly ionized. For the experimental set-up in FIG. 6, the plasma electron density is directly measured by laser interferometry and shown in FIG. 10A, marked as nₑ^{plasma}.

Based on equation 5, the x-ray signals give the measurement for the beam electron density once the bulk electron density is measured.

FIGS. 10 A and B show the experimental results obtained by operation of the apparatus of FIG. 6. Prior to the plasma injection, the coils are energized 40 ms before t=0 and the coil current is kept at constant value during the time period shown in FIG. 10A. In addition, the electron beam was turned on 30 μs before t=0 and operated at 3 A of injection current at 7.2 kV and was maintained on until t=150 μs. Prior to plasma injection, the x-ray diode signals between t=−5 μs and t=0 provide an estimate for the background noise data since there are no plasma ions to produce beam induced bremsstrahlung x-ray emission during this time period. Practically zero signals in x-ray diodes demonstrate good spatial collimation of x-ray detectors and sufficient covering of any metallic surfaces in the line of sight for the x-ray detectors using plastic materials to suppress the spurious x-ray emission. At t=0, two co-axial plasma injectors start with stored energy between 2.6 kJ and 5.6 kJ in the high voltage capacitors, resulting in average total input powers between 370 MW and 800 MW for 7 μs. It is noted that the input power is much higher than the previously estimated 23 MW due to circuit inefficiency and inherent plasma loss in the co-axial plasma gun injector. No significant attempts were conducted to improve the injection efficiency since this experimental set-up was designed to provide scientific validation of enhanced electron beam confinement after high beta plasma injection in the cusp system.

Various experimental runs were identified as “shots”. In the case of shot 15610, as shown in FIG. 10A, the plasma density, marked nₑ^{plasma}, increases to 1.6×10¹⁶ cm⁻³ as the plasma from the injectors are successfully transported to the magnetic cusp system. At the same time, the flux loop data, marked ΔB, shows clear sign of electron diamagnetic effect associated with the high β plasma injection. Even with plasma injection into cusp system, the x-ray signals are low between t=8-13 μs even after the plasma density reaches its peak value of 1.6×10¹⁶ cm⁻³ at t=9 μs. However, shortly after the peaking of flux loop data at t=12 μs, the x-ray diode registers strong increases in hard x-ray emission, while the bulk plasma density varies little. This represents the beginnings of the enhanced electron beam confinement after high β plasma injection into the cusp system. It is noted that the x-ray results in FIGS. 10A and 10B are from the x-ray diode viewing the central plasma through the cusp opening in the face of coil. The x-ray results from the x-ray diode viewing the central plasma through the cusp opening in the corner of coils is omitted for the simplicity as the results are similar to the x-ray diode for the face of coil. The increase in x-ray emission builds up for 4-5 μs and reaches a plateau between t=19-21 μs. At t=21 μs, the x-ray emission signal drops rapidly toward zero within 1-1.5 μs, while plasma density and flux loop data show only gradual decrease during that time period. This condition marks the end of the enhanced electron beam confinement phase. The enhanced electron beam confinement phase is represented by the cross sectioned area of FIG. 10A.

This temporal behavior of the x-ray emission signal can be explained as follows and clearly demonstrates the causality of high β plasma to the improved confinement in the cusp magnetic fields as postulated by Grad. Initially, the beam electrons are confined poorly in the magnetic cusp system, resulting in very low x-ray emission. After the plasma injection, the cusp system undergoes a transition to exhibit enhanced electron confinement due to the presence of high β plasma and corresponding electron diamagnetism. The increase in hard x-ray emission corresponds to the increase in beam electron concentration, showing that beam electrons are now better confined in the magnetic cusp in the presence of high β plasma. In the experimental test set up, however, the plasma pressure in the cusp decreases over time due to the cooling of plasma. It is noted that the test set up does not have a subsequent plasma heating system after the initial plasma injection to compensate the plasma cooling, and the beam electron injection power is too low to maintain high β plasma in the cusp. The decrease in plasma β is clearly shown by the gradual decay of flux loop data, AB, starting from t=14 μs. As a result, the enhanced electron beam confinement phase at high β state is only temporary and it reverts back to the poor electron beam confinement phase when plasma β becomes substantially low. When this transition occurs (end of enhanced electron beam confinement phase), all the previously confined high energy electrons will leave the magnetic cusp rapidly, which results in a rapid decrease in x-ray emission at t=21 μs. This temporal behavior of the x-ray emission signal (a rise and a rapid decay) is observed only when there is sufficient injected energy by the plasma injector, as shown in FIG. 10B. For example, the experimental system shown in FIG. 6 exhibits the enhanced electron beam confinement when the injectors utilizes 4 kJ (shot 15649) and 5.6 kJ (shot 15640) of stored energy in the capacitor to produce initial plasmas, corresponding to average input powers of 570 MW and 800 MW. When the injector utilizes only 2.6 kJ (shot 15645) of stored energy or 380 MW of input power, no increase is observed in x-ray emission with plasma injection.

This result is the first ever experimental measurement that validates the enhanced electron confinement in the cusp magnetic system by the presence of high β plasma.

Formation of Potential Wells and Fusion Reactions

Having demonstrated the enhancement electron confinement during the high electron beam confinement phase, the present embodiments utilizes electron beam injectors to produce a deep negative potential well within the central region of the plasma system. In addition, the electron beam injectors can provide heating to the initially formed plasma to sustain the high beta state in the cusp magnetic confinement region. For a 5 T cusp magnetic fields with 80 cm radius, the required electron density to reach β=1 condition is 6.2×10¹⁷ cm⁻³ for 100 eV plasma injection. The energy transfer time from the injected electron beam at 50 keV to 100 eV plasma is 0.62 μs at this density. In comparison, the expected electron beam confinement time is 0.13 s based on Equation 1. As such, 50 keV electron beams will efficiently transfer their energy to the high beta plasma in the cusp magnetic confinement region. If the beam power is sufficiently high, plasma heating by the electron beam compensates the natural plasma cooling after initial plasma initiation. Furthermore, as discussed earlier, when the electron injection power is increased to the level that compensates for cusp plasma loss, substantially all of the electrons in the plasma in the cusp magnetic confinement region (formed with relatively low energy electrons in the range of, for example, 5-1000 eV, from the plasma initiators) are replaced with high energy electrons at the beam energy. In the case of 50 keV electron injection to 5 T cusp system with 80 cm radius, the corresponding beam power is 165 MW based on Equation 1. Though large, this level of beam power is practically available. In comparison, the electron beam power to sustain high beta plasma is much more than 165 MW without the use of plasma initiators. For example, for the same 5 T cusp system with 80 cm radius, the electron density is 1.2×10¹³ cm⁻³ for β=0.01 with the average electron energy of 50 keV. The energy transfer time from the injected electrons to the plasma in the cusp is 310 μs at this density. In comparison, the expected electron confinement time is 2.1 μs based on Equation 2. As such, 50 keV electron beams will likely escape the cusp system before transferring their energy to the low beta plasma. As estimated previously, the required electron beam power is about 200 GW to maintain a β=0.01 plasma in the cusp. Once the high beta plasma is sustained with the electrons whose energy is equal to the beam energy via efficient beam heating at high beta, it is then possible to produce a sufficiently negative potential well necessary for fusion reaction. In reference to FIG. 10A, the electron beam is preferably turned on at least by the mid to latter stages of the high electron beam confinement phase. The electron beam may also be turned on at the beginning or before the beginning of the high electron beam confinement phase. It is also noted that the electron beam energy may be varied in time to control the value of the negative well.

The fusion fuel is may be introduced, for example, before, after or at about the same time as the electron beam injection and potential well formation. The fusion fuel is a neutral fuel at the time of its introduction into the plasma chamber and may be supplied as a liquid, gas or solid. The neutral fusion fuel is ionized at the boundary of the plasma region as it is heated by the plasma within the plasma chamber. Typically, the fusion fuel is introduced in a steady state manner at a fairly low rate on the order of milligrams/sec.

Neutron Generator

It certain embodiments of the invention it is possible to form a neutron generator without the need for formation of a deep potential well. For example, after formation of the high density plasma utilizing the pulse initiators (e.g., injectors) as described above, one may inject high energy ion beams on the order of 50 KeV into the high density plasma to cause neutron generation by fusion reactions (e.g., D−D, D=T). This same technique may be used for medical isotope production and nuclear waste transmutation.

Additional Components for a Fusion Reactor

Once the deep potential well is established by the efficient electron beam injection, the ions will undergo fusion reaction. The followings are most often cited fusion reactions.

D+T→⁴He(3.5 MeV)+n(14.1 MeV)

D+D→T(1 MeV)+p(3 MeV) or ³He(0.8 MeV)+n(2.45 MeV)

D+³He→⁴He(3.6 MeV)+p(14.7 MeV)

P+¹¹B→3⁴He(8.7 MeV)

In all of the cases, the fusion products have very high energy. By choosing appropriate fusion fuels and employing various collection systems for those fusion products, one can turn a nuclear fusion reactor in accordance with the embodiments of the invention into neutron generators, medical isotope production, transmutation of nuclear wastes and fusion power plants, depending on the overall system efficiency. Since the fusion fuel is consumed by the fusion reaction, the reactor requires a fusion fuel supply 105 shown in FIG. 4. The fusion fuel supply can utilize gas, liquid droplet or pellet injection. These fusion fuels will be ionized as they enter the boundary layer of confined plasma. The use of high density plasmas ensures that all of those fusion fuels will be ionized near the boundary. Electrons from the ionization will be pushed outward as they do not have sufficient energy to overcome the potential well. On the other hand, ions will be pushed inward as they gain kinetic energy from the potential well and subsequently participate in the fusion reaction.

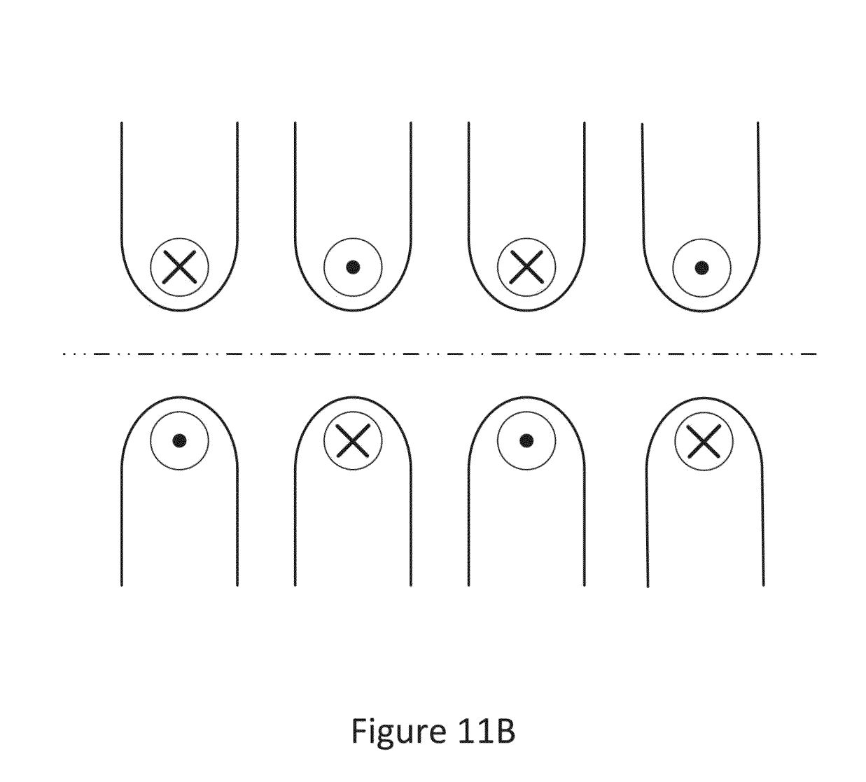

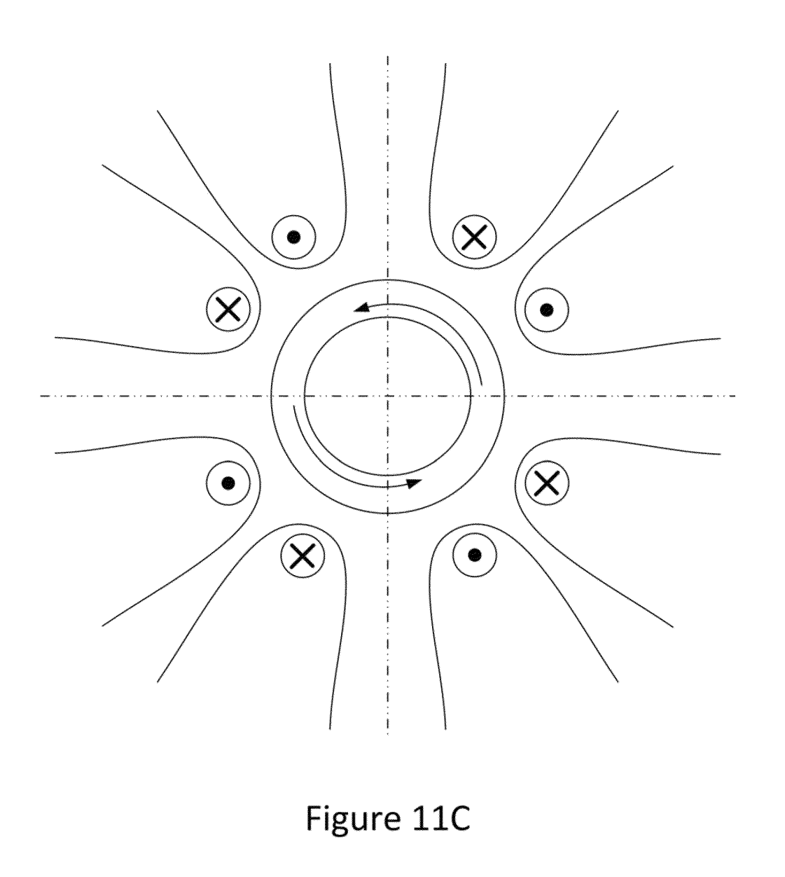

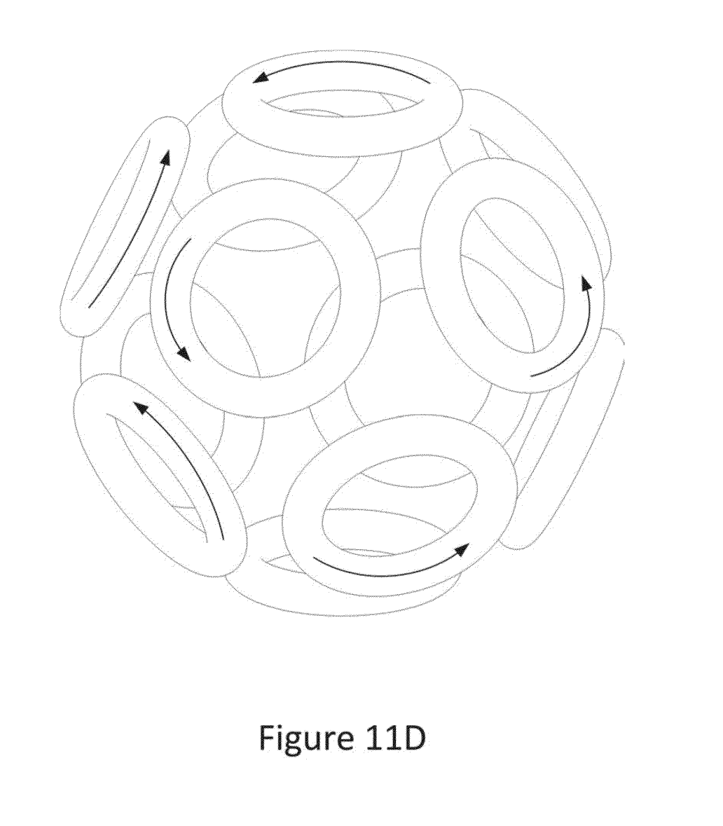

It is noted that embodiments of the current invention are applicable to various magnetic cusp configurations in addition to the 6 coil system as described in FIGS. 2, 4 and 6. FIGS. 11A-11D show examples of magnetic cusp configurations that can also be utilized. They are: FIG. 11A axis symmetric spindle cusp system, FIG. 11B “picket fence” cusp system, FIG. 11C 6 coil cusp system, FIG. 11D 12 coil cusp system, known as “Dodecahedron” configuration. In addition, other polyhedral magnetic cusp configuration such as Icosidodecahedron can be utilized as well.

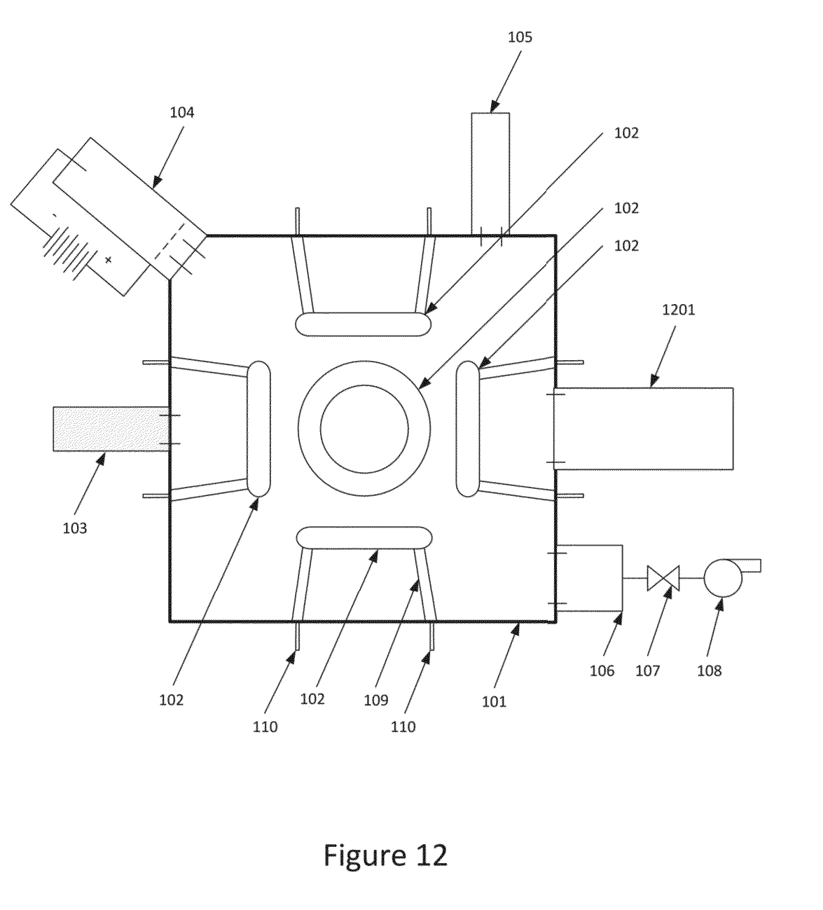

FIG. 12 shows another embodiment of the current invention. This embodiment uses the same components as in FIG. 4, but additionally includes a neutral beam injection 1201 to control the ion energy confined in the potential well. In general, one of the side effects for the IEC system is the increased concentration of low energy ions in the central region of the potential well. By utilizing high energy neutral beam injection, one can replace these low energy ions in the central region with the high energy ions via charge-exchange collision with the injected neutral beam. The neutral beam can penetrate the magnetic cusp structure as well as electrostatic potential well due to its lack of charge. Once the neutral beam undergoes charge-exchange collisions, it acquires charge and becomes confined in the potential well assuming the neutral beam injection energy is lower than the potential well depth. On the other hand, the slow ions now turn into neutral particles by gaining electrons from the neutral beam. Once they become neutralized, they are no longer confined in the potential well and leave the system.

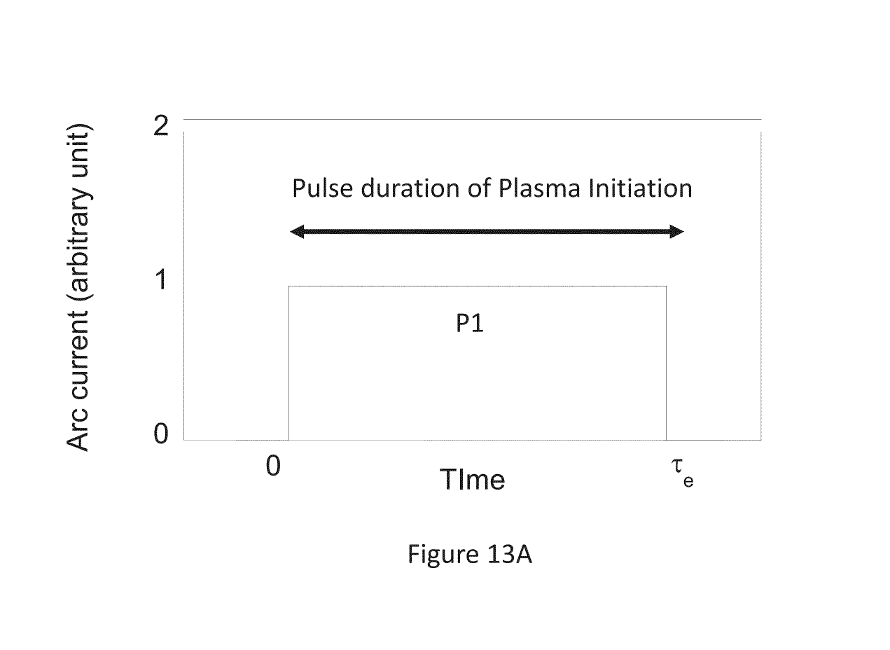

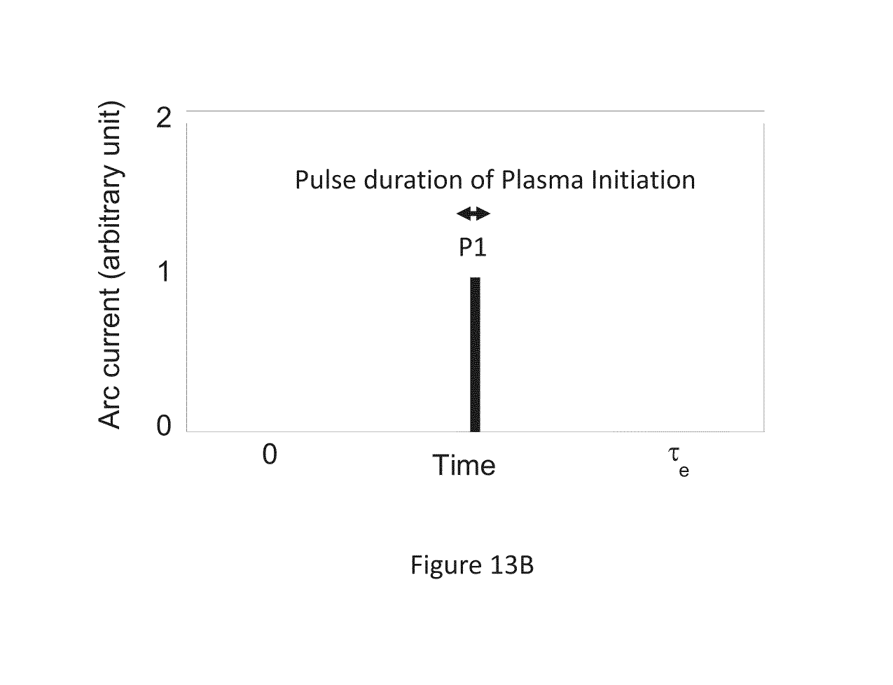

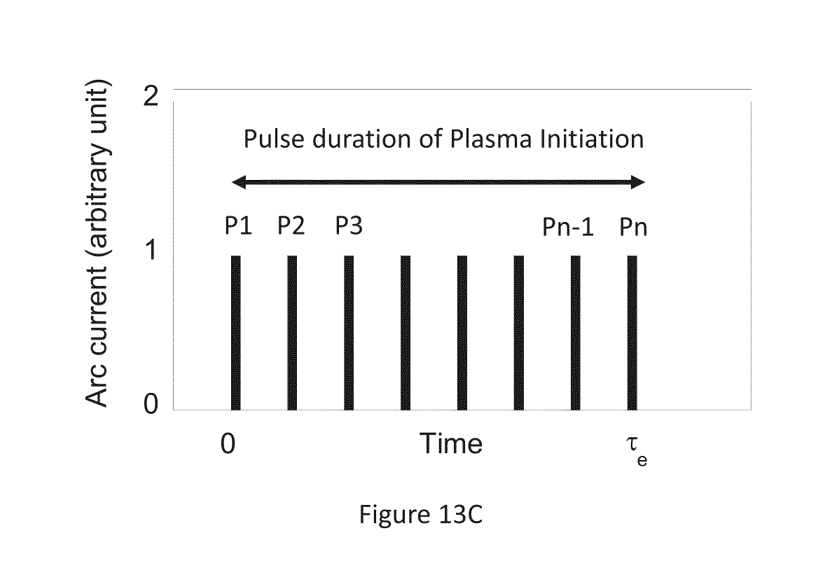

FIGS. 13A and 13B illustrate various pulse timing of plasma initiators. The time scale of the initiator (or more generally, the initial high density plasma formation) is on the order of or comparable to the electron confinement time τₑ of Equation 2, as shown in FIG. 13A. The pulse duration of initiator can also be much shorter than the electron confinement time τₑ of Equation 2, as shown in FIG. 13B. In the case multiple plasma initiators are used, the individual initiator can have a much shorter pulse duration, while the entire time scale of the initiator is on the order of or comparable to the electron confinement time τₑ of Equation 2, as shown in FIG. 13C where P1, P2, . . . Pn represent the short pulse durations of the individual initiators within the multiple initiator system.

The nuclear fusion reactions produced as describe above may be useful for a number of applications aside from fusion power production such as a neutron generator, a medical isotope generator or a nuclear waste transmutation device.

There are various implementations of the invention. Implementation 1 is directed toward an apparatus for generating nuclear fusion reactions, comprising a reactor chamber; a coil system, having coils generating cusp magnetic fields within the reaction chamber; a plasma initiator for generating a high beta plasma within the reaction chamber; an electron injector; a fusion fuel injector replenishing consumed ions by nuclear fusion reaction; wherein the plasma initiator produces the high beta plasma inside the reaction chamber for electron confinement in the reaction chamber; and wherein the electron injector produces a plasma potential well within the reaction chamber to confine ions and accelerates ions to fusion relevant energies within the reaction chamber.

Implementation 2 adds to the implementation 1 the feature that the plasma initiator operates with a pulse duration between 0.1 and 10 times the electron confinement time determined by Equation 2.

Implementation 3 adds to any one of the above implementations the feature that the plasma initiator operates with a maximum pulse duration between 0.3-3, 0.5-5, 1-3, 3-10, 5-20, or approximately equal or equal to the electron confinement time of Equation 2.

Implementation 4 adds to any one of the above implementations the feature that the plasma initiator operates with a pulse duration less than 0.1 times the electron confinement time of Equation 2.

Implementation 5 adds to any one of the above implementations the feature that the temperature of the plasma generated by the plasma initiator is in the range of 5-1000 eV, or more preferably in a range selected from one of 10-500 eV, 10-100 eV, 20 eV-250 eV, 50 eV-300 eV, 50 eV-500 eV, and 100 eV-1000 eV.

Implementation 6 adds to any one of the above implementations the feature that the plasma initiator operates with electron energies selected from one of the ranges 5-1000 eV, 10-500 eV, 10-100 eV, 20-250 eV, 50-300 eV, 50-500 eV, and 100-1000 eV.

Implementation 7 adds to any one of the above implementations the feature that the maximum magnetic field at cusp points generated by the coil system is in the range of 0.5-20 Tesla.

Implementation 8 adds to any one of the above implementations the feature that the maximum magnetic field at cusp points generated by the coil system is in the range of any one of 1-15, 3-12, 4-10, and 5-8 Tesla.

Implementation 9 adds to any one of the above implementations the feature that the plasma initiator operates with sufficient energy to produce the high beta plasma inside the cusp with the plasma β between 0.1 and 10.

Implementation 10 adds to any one of the above implementations the feature that the plasma initiator operates with sufficient energy to produce the high beta plasma inside the cusp with the plasma β between 0.2-5.0, 0.3-3.0, 0.5-2.0, 0.7-1.5, 0.8-1.2, 0.9-1.1, or β approximately equal to or equal to 1.

Implementation 11 adds to any one of the above implementations the feature that the plasma initiator has an energy given by 0.5-50 times the energy of Equation 3.

Implementation 12 adds to any one of the above implementations the feature that the plasma initiator has an energy given by 0.5-30, 0.5-10, 1-30, 1-20, 1-10, 5-30, 5-20, and 5-10 times the energy of Equation 3.

Implementation 13 adds to any one of the above implementations the feature that the magnetic field has cusp points and the magnetic field at the cusp points generated by the coil system is in the range of 0.5-20 Tesla, and the plasma initiator operates with sufficient energy to produce the high beta plasma inside the cusp with the plasma β between 0.1 and 10.

Implementation 14 adds to any one of the above implementations the feature that the electron injector produces a plasma potential well of 10 keV or higher.

Implementation 15 adds to any one of the above implementations the feature that the electron injector produces a plasma potential well of at least 50 keV.

Implementation 16 adds to any one of the above implementations the feature that the electron injector produces an electron beam with a beam energy within one of the ranges of 10-1000 keV, 10-200 keV, 25-150 keV, 50-300 keV, 75-500 keV and, 100-1000 keV and produces the plasma potential well.

Implementation 17 adds to any one of the above implementations the feature that the plasma initiator comprises a co-axial plasma gun using at least one of gas, liquid droplet or solid material for plasma generation.

Implementation 18 adds to any one of the implementations 1-16 the feature that the plasma initiator comprises a field reversed configuration (FRC) plasma generator.

Implementation 19 adds to any one of the implementations 1-16 the feature that the plasma initiator comprises a spheromak plasma generator.

Implementation 20 adds to any one of the implementations 1-16 the feature that the plasma initiator comprises a device for laser ablation and ionization of one of gas, liquid droplet or solid material inside the cusp magnetic fields.

Implementation 21 adds to any one of the implementations 1-16 the feature that the plasma initiator comprises a pinch plasma generator.

Implementation 22 adds to any one of the implementations 1-16 and 21 the feature that the plasma initiator comprises a pinch plasma generator having a plasma forming material in the shape of wire-like configuration.

Implementation 23 adds to any one of the implementations 1-16 and 21-22, the feature that the plasma initiator comprises a pinch plasma generator having a reaction chamber, plasma electrodes and a plasma forming material in a tailored configuration having a larger area adjacent the electrodes and a smaller area in the center of the reaction chamber.

Implementation 24 adds to any one of the implementations 1-16 and 21-22 the feature that the plasma initiator comprises a pinch plasma generator having a plurality of plasma forming materials, each having a wire-like configuration.

Implementation 25 adds to any one of the implementations 1-16 and 21-22 the feature that the plasma initiator comprises a pinch plasma generator having a first plurality of plasma forming materials, each having a wire-like configuration and a second plurality of plasma forming materials, each having a wire-like configuration, the first plurality of plasma forming materials oriented perpendicular to the second plurality of plasma forming materials.

Implementation 26 adds to any one of the implementations 1-16 and 21-22 the feature that the plasma initiator comprises a pinch plasma generator having a first plasma forming material having a wire-like configuration and a second plasma forming material having a wire-like configuration, the first plasma forming material oriented perpendicular to the second plasma forming material.

Implementation 27 adds to any one of the implementations 1-16 the feature that the plasma initiator comprises a pinch plasma generator having a plasma forming material comprising a gas jet.

Implementation 28 adds to any one of the implementations 1-16 the feature that the plasma initiator comprises a pinch plasma generator having a plasma forming material comprising one of liquid droplets or microscale particles.

Implementation 29 adds to any one of the above implementations the feature that the cusp magnetic fields form axis symmetric spindle cusp fields.

Implementation 30 adds to any one of implementations 1-28, the feature that the cusp magnetic fields comprise a picket fence cusp configuration.

Implementation 31 adds to any one of the above implementations the feature that the cusp magnetic fields are generated by 6 a coil polyhedral configuration.

Implementation 32 adds to any one of implementations 1-30 the feature that the cusp magnetic fields are generated by a 12 coil polyhedral configuration.

Implementation 33 adds to any one of implementations 1-30 the feature that the cusp magnetic fields are generated by a 20 coil polyhedral configuration.

Implementation 34 adds to any one of the above implementations the feature that the plasma initiator comprises one or more pulsed plasma initiators.

Implementation 35 adds to any one of the above implementations the feature that the electron injector comprising a plurality of electron injectors.

Implementation 36 adds to any one of the above implementations the feature that the apparatus comprises one of a neutron generator, a medical isotope generator or a nuclear waste transmutation device.

Implementation 37 adds to any one of the above implementations the additional feature of a neutral beam injector, wherein the neutral beam injector removes low energy ions from the cusp magnetic fields

Implementation 38 may be characterized as a method of producing nuclear fusion comprising: providing a reaction chamber; generating cusp magnetic fields within the reaction chamber; utilizing a plasma initiator, generating a beta pressure plasma within the reaction chamber for confining high energy electrons in the reaction chamber; injecting electrons into the reaction chamber for producing a plasma potential well within the reaction chamber to confine ions and accelerates ions to fusion relevant energies within the reaction chamber; and replenishing ions consumed by nuclear fusion reactions.

Implementation 39 adds to implementation 38 the additional feature of adding high energy ions into the reaction chamber by utilizing neutral beam injection into the reaction chamber.

Implementation 40 adds to any one of implementations 38-39 the additional feature of operating the plasma initiator with a pulse duration between 0.1 and 10 times the electron confinement time determined by Equation 2.

Implementation 41 adds to any one of implementations 38-39 the additional feature of operating the plasma initiator with a maximum pulse duration between 0.3-3, 0.5-5, 1-3, 3-10, 5-20, or approximately equal or equal to the electron confinement time of Equation 2.

Implementation 42 adds to any one of implementations 38-39 the additional feature of operating the plasma initiator with a pulse duration less than 0.1 times the electron confinement time of Equation 2.

Implementation 43 adds to any one of implementations 38-42 the additional feature of operating the plasma initiator to generate plasma temperatures in the range of 5-1000 eV, or more preferably in a range selected from one of 10-500 eV, 10-100 eV, 20 eV-250 eV, 50 eV-300 eV, 50 eV-500 eV, and 100 eV-1000 eV.

Implementation 44 adds to any one of implementations 38-43 the additional feature of operating the plasma initiator for generating electron energies selected from one of the ranges 5-1000 eV, 10-500 eV, 10-100 eV, 20-250 eV, 50-300 eV, 50-500 eV, and 100-1000 eV.

Implementation 45 adds to any one of implementations 38-44 the additional feature of generating the cusp magnetic fields having a field strength at cusp points in the range of 0.5-20 Tesla.

Implementation 46 adds to any one of implementations 38-44 the additional feature of generating the cusp magnetic fields having a field strength at cusp points in the range of any one of 1-15, 3-12, 4-10, and 5-8 Tesla.

Implementation 47 adds to any one of implementations 38-46 the additional feature of operating the plasma initiator to produce the high beta plasma inside cusp of the cusp magnetic fields with a plasma β between 0.2-5.0, 0.3-3.0, 0.5-2.0, 0.7-1.5, 0.8-1.2, 0.9-1.1, or β approximately equal to or equal to 1.

Implementation 48 adds to any one of implementations 38-47 the additional feature of operating the plasma initiator to have an energy given by 0.5-50 times the energy of Equation 3.

Implementation 49 adds to any one of implementations 38-47 the additional feature of operating the plasma initiator to have an energy given by 0.5-30, 0.5-10, 1-30, 1-20, 1-10, 5-30, 5-20, and 5-10 times the energy of Equation 3.

Implementation 50 adds to any one of implementations 38-49 the additional feature that the magnetic field generated by the coil system is in the range of 0.5-20 Tesla, and the plasma initiator operates with sufficient energy to produce the a plasma β between 0.1 and 10.

Implementation 51 adds to implementations 50 the additional feature that of operating the plasma initiator with a pulse duration of at most 10 times the electron confinement time determined by Equation 2.

Implementation 52 is characterized by a neutron generator comprising: a reactor chamber; a coil system, having coils generating cusp magnetic fields within the reaction chamber; a plasma initiator for generating a high beta plasma within the reaction chamber; an electron injector; an ion injector; a fusion fuel injector replenishing consumed ions by nuclear fusion reaction; wherein the plasma initiator produces the high beta plasma inside the reaction chamber for electron confinement in the reaction chamber; and wherein the electron injector and ion injector heat the plasma for causing fusion reactions to generate neutrons.

Implementation 53 is directed toward an apparatus for generating nuclear fusion reactions, comprising a reactor chamber; a coil system, having coils generating cusp magnetic fields within the reaction chamber; a plasma initiator for generating a high beta plasma within the reaction chamber; an electron injector; a fusion fuel injector replenishing consumed ions by nuclear fusion reaction; wherein the plasma initiator produces the high beta plasma inside the reaction chamber for electron confinement in the reaction chamber; wherein the electron injector produces a plasma potential well within the reaction chamber to confine ions and accelerates ions to fusion relevant energies within the reaction chamber; and wherein the plasma initiator comprises one or more plasma pinch initiators with one or more plasma initiators selected from the group of an injector gun, FRC and laser.

Implementation 54 adds to implementation 53 the feature that one or more of the injector gun, FRC and laser is utilized to provide initial energy to the reactor chamber and one or more pinch initiators are subsequently used to augment the energy within the reaction chamber to produce the high beta plasma.

### REFERENCE LIST

1. Amasa S. Bishop, “Project Sherwood: The U.S. Program In Controlled Fusion”, Chapter 14, p139-p142, (Addison-Wesley, Reading, 1958).
2. J. Berkwoitz, K. O. Freidrichs, H. Goertzel, H. Grad, J. Killeen, and E. Rubin, “Cusped Geometries”, Proceeding of Second U.N. International Conference on Peaceful Uses of Atomic Energy, Geneva, Volume 31, p171-p176, (1958).
3. James L. Tuck, “A New Plasma Confinement Geometry, Nature, Volume 4740, p863-p864, (1960).
4. J. D. Huba, Naval Research Laboratory Plasma Formulary (2013).
5. John Marshall, Jr., “Methods and Means for Obtaining Hydro-magnetically Accelerated Plasma Jet”, U.S. Pat. No. 2,961,559 (1960).
6. James L. Tuck, “High Energy Gaseous Plasma Containment Device”, U.S. Pat. No. 3,031,398 (1962).
7. I. Spalding, “Cusp Containment”, in Advances in Plasma Physics, edited by A. Simon and W. B. Thompson (Wiley, New York, 1971).
8. M. G. Haines, “Plasma Containment in Cusp-Shaped Magnetic Fields”, Nuclear Fusion, Vol. 17, p 811-p858 (1977).
9. R. E. Pechacek, J. R. Greig, M. Raleigh, D. K. Koopman, and A. W. DeSilva, “Measurement of the Plasma Width in a Ring Cusp”, Physical Review Letters, Volume 45, p 256-p 259 (1980).
10. P. T. Farnsworth, “Method and Apparatus for Producing Nuclear-Fusion Reactions”, U.S. Pat. No. 3,386,883 (1968).
11. Robert L. Hirsch, “Apparatus for Generating Fusion Reactions”, U.S. Pat. No. 3,530,036 (1970).
12. Robert L. Hirsch, “Electrostatic Containment in Fusion Reactors”, U.S. Pat. No. 3,664,920 (1972).
13. William C. Elmore, James L. Tuck, and Kenneth M. Watson, “On the Inertial-Electrostatic Confinement of a Plasma”, Physics of Fluids, Volume 2, p239-246 (1959).
14. Robert W. Bussard, “Method and Apparatus for Controlling Charged Particles”, U.S. Pat. No. 4,826,646 (1989).
15. Robert W. Bussard, “The Advent of Clean Nuclear Fusion: Superperformance Space Power and Propulsion”, 57^{th} International Astronautical Congress (2006).
16. Nicholas A. Krall, Michael Coleman, Kenneth C. Maffei, John A. Lovberg, R. A. Jacobsen, Robert W. Bussard, “Forming and Maintaining a Potential Well in a Quasispherical Magnetic Trap”, Physics of Plasmas, Volume 2, p146-p160 (1995).

What is claimed is:

1. An apparatus generating nuclear fusion reactions, comprising:
a reactor chamber;
a coil system, having coils generating cusp magnetic fields within the reaction chamber;
a plasma initiator for generating a high beta plasma within the reaction chamber;
an electron injector;
a fusion fuel injector replenishing consumed ions by nuclear fusion reaction;
wherein the plasma initiator produces the high beta plasma inside the reaction chamber for electron confinement in the reaction chamber; and
wherein the electron injector produces a plasma potential well within the reaction chamber to confine ions and accelerates ions to fusion relevant energies within the reaction chamber.

2. The apparatus of claim 1, wherein the plasma initiator operates with a pulse duration between 0.1 and 10 times the electron confinement time determined by Equation 2.

3. The apparatus of claim 1, wherein the plasma initiator operates with a maximum pulse duration between 0.3-3, 0.5-5, 1-3, 3-10, 5-20, or approximately equal or equal to the electron confinement time of Equation 2.

4. The apparatus of claim 1, wherein the plasma initiator operates with a pulse duration less than 0.1 times the electron confinement time of Equation 2.

5. The apparatus of claim 1 wherein the temperature of the plasma generated by the plasma initiator is in the range of 5-1000 eV, or more preferably in a range selected from one of 10-500 eV, 10-100 eV, 20 eV-250 eV, 50 eV-300 eV, 50 eV-500 eV, and 100 eV-1000 eV.

6. The apparatus of claim 1, wherein the plasma initiator operates with electron energies selected from one of the ranges 5-1000 eV, 10-500 eV, 10-100 eV, 20-250 eV, 50-300 eV, 50-500 eV, and 100-1000 eV.

7. The apparatus of claim 1, wherein the maximum magnetic field at cusp points generated by the coil system is in the range of 0.5-20 Tesla.

8. The apparatus of claim 1, wherein the maximum magnetic field at cusp points generated by the coil system is in the range of any one of 1-15, 3-12, 4-10, and 5-8 Tesla.

9. The apparatus of claim 1, wherein the plasma initiator operates with sufficient energy to produce the high beta plasma inside the cusp with the plasma β between 0.1 and 10.

10. The apparatus of claim 1, wherein the plasma initiator operates with sufficient energy to produce the high beta plasma inside the cusp with the plasma β between 0.2-5.0, 0.3-3.0, 0.5-2.0, 0.7-1.5, 0.8-1.2, 0.9-1.1, or β approximately equal to or equal to 1.

11. The apparatus of claim 1, wherein the plasma initiator has an energy given by 0.5-50 times the energy of Equation 3.

12. The apparatus of claim 1, wherein the plasma initiator has an energy given by 0.5-30, 0.5-10, 1-30, 1-20, 1-10, 5-30, 5-20, and 5-10 times the energy of Equation 3.

13. The apparatus of claim 1, wherein the magnetic field has cusp points and the magnetic field at the cusp points generated by the coil system is in the range of 0.5-20 Tesla, and the plasma initiator operates with sufficient energy to produce the high beta plasma inside the cusp with the plasma β between 0.1 and 10.

14. The apparatus of claim 1, wherein the electron injector produces a plasma potential well of 10 keV or higher.

15. The apparatus of claim 1, wherein the electron injector produces a plasma potential well of at least 50 keV.

16. The apparatus of claim 1, wherein the electron injector produces an electron beam with a beam energy within one of the ranges of 10-1000 keV, 10-200 keV, 25-150 keV, 50-300 keV, 75-500 keV and, 100-1000 keV and produces a plasma potential well.

17. The apparatus of claim 1, wherein the plasma initiator comprises a co-axial plasma gun using at least one of gas, liquid droplet or solid material for plasma generation.

18. The apparatus of claim 1, wherein the plasma initiator comprises a field reversed configuration (FRC) plasma generator.

19. The apparatus of claim 1, wherein the plasma initiator comprises a spheromak plasma generator.

20. The apparatus of claim 1, wherein the plasma initiator comprises a device for laser ablation and ionization of one of gas, liquid droplet or solid material inside the cusp magnetic fields.

21. The apparatus of claim 1, wherein the plasma initiator comprises a pinch plasma generator disposed inside the cusp magnetic fields.

22. The apparatus of claim 1, wherein the plasma initiator comprises a pinch plasma generator having a plasma forming material in the shape of wire-like configuration.

23. The apparatus of claim 1, wherein the plasma initiator comprises a pinch plasma generator having a reaction chamber, plasma electrodes and a plasma forming material in a tailored configuration having a larger area adjacent the electrodes and a smaller area in the center of the reaction chamber.

24. The apparatus of claim 1, wherein the plasma initiator comprises a pinch plasma generator having a plurality of plasma forming materials, each having a wire-like configuration.

25. The apparatus of claim 1, wherein the plasma initiator comprises a pinch plasma generator having a first plurality of plasma forming materials, each having a wire-like configuration and a second plurality of plasma forming materials, each having a wire-like configuration, the first plurality of plasma forming materials oriented perpendicular to the second plurality of plasma forming materials.

26. The apparatus of claim 1, wherein the plasma initiator comprises a pinch plasma generator having a first plasma forming material having a wire-like configuration and a second plasma forming material having a wire-like configuration, the first plasma forming material oriented perpendicular to the second plasma forming material.

27. The apparatus of claim 1, wherein the plasma initiator comprises a pinch plasma generator having a plasma forming material comprising a gas jet.

28. The apparatus of claim 1, wherein the plasma initiator comprises a pinch plasma generator having a plasma forming material comprising one of liquid droplets or microscale particles.

29. The apparatus of claim 1, wherein the cusp magnetic fields form axis symmetric spindle cusp fields.

30. The apparatus of claim 1, wherein the cusp magnetic fields comprise a picket fence cusp configuration.

31. The apparatus of claim 1, wherein the cusp magnetic fields are generated by 6 a coil polyhedral configuration.

32. The apparatus of claim 1, wherein the cusp magnetic fields are generated by a 12 coil polyhedral configuration.

33. The apparatus of claim 1, wherein the cusp magnetic fields are generated by a 20 coil polyhedral configuration.

34. The apparatus of claim 1, wherein the plasma initiator comprises one or more pulsed plasma initiators.

35. The apparatus of claim 1, further comprising a plurality of electron injectors.

36. The apparatus of claim 1, wherein the apparatus comprises one of a neutron generator, a medical isotope generator or a nuclear waste transmutation device.

37. An apparatus of claim 1, further comprising:
a neutral beam injector;
wherein the neutral beam injector removes low energy ions from the cusp magnetic fields

38. A method of producing nuclear fusion comprising:
providing a reaction chamber;
generating cusp magnetic fields within the reaction chamber;
utilizing a plasma initiator, generating a beta pressure plasma within the reaction chamber for confining high energy electrons in the reaction chamber;
injecting electrons into the reaction chamber for producing a plasma potential well within the reaction chamber to confine ions and accelerates ions to fusion relevant energies within the reaction chamber; and
replenishing ions consumed by nuclear fusion reactions.

39. The method of claim 38 further comprising:
adding high energy ions into the reaction chamber by utilizing neutral beam injection into the reaction chamber.

40. The method of claim 38, further comprising operating the plasma initiator with a pulse duration between 0.1 and 10 times the electron confinement time determined by Equation 2.

41. The method of claim 38, further comprising operating the plasma initiator with a maximum pulse duration between 0.3-3, 0.5-5, 1-3, 3-10, 5-20, or approximately equal or equal to the electron confinement time of Equation 2.

42. The method of claim 38, further comprising operating the plasma initiator with a pulse duration less than 0.1 times the electron confinement time of Equation 2.

43. The method of claim 38, comprising operating the plasma initiator to generate plasma temperatures in the range of 5-1000 eV, or more preferably in a range selected from one of 10-500 eV, 10-100 eV, 20 eV-250 eV, 50 eV-300 eV, 50 eV-500 eV, and 100 eV-1000 eV.

44. The method of claim 38, comprising operating the plasma initiator for generating electron energies selected from one of the ranges 5-1000 eV, 10-500 eV, 10-100 eV, 20-250 eV, 50-300 eV, 50-500 eV, and 100-1000 eV.

45. The method of claim 38, comprising generating the cusp magnetic fields having a field strength at cusp points in the range of 0.5-20 Tesla.

46. The method of claim 38, comprising generating the cusp magnetic fields having a field strength at cusp points in the range of any one of 1-15, 3-12, 4-10, and 5-8 Tesla.

47. The method of claim 38, comprising operating the plasma initiator to produce the high beta plasma inside cusp of the cusp magnetic fields with a plasma β between 0.2-5.0, 0.3-3.0, 0.5-2.0, 0.7-1.5, 0.8-1.2, 0.9-1.1, or β approximately equal to or equal to 1.

48. The method of claim 38, further comprising operating the plasma initiator to have an energy given by 0.5-50 times the energy of Equation 3.

49. The method of claim 38, further comprising operating the plasma initiator to have an energy given by 0.5-30, 0.5-10, 1-30, 1-20, 1-10, 5-30, 5-20, and 5-10 times the energy of Equation 3.

50. The method of claim 38, wherein the magnetic field generated by the coil system is in the range of 0.5-20 Tesla, and the plasma initiator operates with sufficient energy to produce the a plasma β between 0.1 and 10.

51. The method of claim 50, further comprising operating the plasma initiator with a pulse duration of at most 10 times the electron confinement time determined by Equation 2.

52. A neutron generator comprising:
a reactor chamber;
a coil system, having coils generating cusp magnetic fields within the reaction chamber;
a plasma initiator for generating a high beta plasma within the reaction chamber;
an electron injector;
an ion injector;
a fusion fuel injector replenishing consumed ions by nuclear fusion reaction;
wherein the plasma initiator produces the high beta plasma inside the reaction chamber for electron confinement in the reaction chamber; and
wherein the electron injector and ion injector heat the plasma for causing fusion reactions to generate neutrons.

53. An apparatus generating nuclear fusion reactions, comprising:
a reactor chamber;
a coil system, having coils generating cusp magnetic fields within the reaction chamber;
a plasma initiator for generating a high beta plasma within the reaction chamber;
an electron injector;
a fusion fuel injector replenishing consumed ions by nuclear fusion reaction;
wherein the plasma initiator produces the high beta plasma inside the reaction chamber for electron confinement in the reaction chamber;
wherein the electron injector produces a plasma potential well within the reaction chamber to confine ions and accelerates ions to fusion relevant energies within the reaction chamber; and
wherein the plasma initiator comprises one or more plasma pinch initiators with one or more plasma initiators selected from the group of an injector gun, FRC and laser.

54. An apparatus generating nuclear fusion reactions as recited in claim 53, wherein one or more of the injector gun, FRC and laser is utilized to provide initial energy to the reactor chamber and one or more pinch initiators are subsequently used to augment the energy within the reaction chamber to produce the high beta plasma.
